(19) United States
(12) Patent Application Publication
(10) Pub. No.: US 2015/0227785 A1
(43) Pub. Date: Aug. 13, 2015

(54) INFORMATION PROCESSING APPARATUS, INFORMATION PROCESSING METHOD, AND PROGRAM

(71) Applicant: OBIC BUSINESS CONSULTANTS CO., LTD., Tokyo (JP)

(72) Inventors: Shigefumi Wada, Tokyo (JP); Katsuhiko Karakama, Tokyo (JP)

(73) Assignee: OBIC BUSINESS CONSULTANTS CO., LTD., Tokyo (JP)

(21) Appl. No.: 14/422,260

(22) PCT Filed: Nov. 30, 2012
(86) PCT No.: PCT/JP2012/081034

§ 371 Date: Feb. 18, 2015

(30) Foreign Application Priority Data
Aug. 20, 2012 (JP) 2012-181864

(51) Int. Cl. G06K 9/00; G06Q 20/20; G06F 17/30

(52) U.S. Cl. CPC G06K 9/00442; G06F 17/30247; G06Q 20/209

(57) ABSTRACT

An information processing apparatus includes: a receipt image storage unit in which a receipt image, which is an image of a receipt, can be stored; a receipt image receiving unit that receives the receipt image; a receipt image accumulating unit that accumulates the receipt image received by the receipt image receiving unit, in the receipt image storage unit; a slip information storage unit in which a slip information record can be stored, the slip information record being a record in which slip information, which is information of a slip relating to the receipt image, can be stored; and an association providing unit that associates the receipt image stored in the receipt image storage unit, with the slip information record in which the slip information relating to that receipt image is to be stored.

### CROSS-REFERENCE TO RELATED APPLICATION

This is a U.S. national phase application under 35 U.S.C. §371 of International Patent Application No. PCT/JP2012/081034, filed on Nov. 30, 2012, and claims benefit of priority to Japanese Patent Application No. JP 2012-181864, filed on Aug. 20, 2012. The International Application was published on Feb. 27, 2014, as International Publication No. WO 2014/030266 under PCT Article 21(2). The entire contents of these Applications are hereby incorporated herein by reference.

### TECHNICAL FIELD

The present invention relates to an apparatus and the like for inputting information of a slip, for example.

### BACKGROUND ART

Examples of known conventional information processing apparatuses used for account processing and the like include an apparatus in which slip input data input by an operator can be stored. See, for example, Japanese Patent Application Publication No. 2006-227694 at, among others, page 1 and FIG. 1.

However, conventional information processing apparatuses used for account processing and the like are such that information of a slip is managed as electronic data in a database, whereas a receipt is paper and is managed by being attached to a notebook or the like. Accordingly, the receipt and data of the slip are separately managed, and, thus, information of the slip relating to the receipt cannot be properly managed. For example, the receipt and information of the slip generated for this receipt cannot be managed in an integrated manner in association with each other.

Furthermore, in conventional cases, in order to input information of slips relating to receipts to an accounting system or the like for managing information of slips, it is necessary to input information written on the receipts at proper positions in proper forms. Thus, for a person other than those skilled in the slip input, it is difficult to input information of slips relating to receipts. Accordingly, for example, corporations such as companies using such an accounting system have to particularly employ operators or the like for inputting information of slips, which significantly increases the cost. For example, not all employees who have acquired receipts can input information of slips relating to the receipts, and, thus, slip input processing and the like in the company cannot be distributed. Thus, in conventional cases, it is not possible to properly and efficiently perform slip input of information relating to receipts. As a result, it is not possible to properly manage information relating to receipts.

### SUMMARY

The present invention is directed to an information processing apparatus, including: a receipt image storage unit in which a receipt image, which is an image of a receipt, is stored; a receipt image receiving unit that receives the receipt image; a receipt image accumulating unit that accumulates the receipt image received by the receipt image receiving unit, in the receipt image storage unit; a slip information storage unit in which a slip information record is stored, the slip information record being a record in which slip information, which is information of a slip relating to the receipt image, is stored; and an association providing unit that associates the receipt image stored in the receipt image storage unit, with the slip information record in which the slip information relating to that receipt image is to be stored.

With this configuration, a receipt image and slip information for a receipt shown in the receipt image can be stored in association with each other, and information relating to the receipt can be properly managed.

Furthermore, the information processing apparatus of the present invention is such that the information processing apparatus further includes a record generating unit that automatically generates a slip information record in which slip information corresponding to the receipt image received by the receipt image receiving unit is to be stored, and accumulates the automatically generated slip information record in the slip information storage unit, wherein the association providing unit associates the slip information record generated by the record generating unit with the receipt image corresponding to the slip information record stored in the receipt image storage unit.

With this configuration, slip information relating to a receipt can be automatically acquired from a receipt image, and the acquired slip information can be accumulated in a slip information record associated with this receipt image, so that slip input of information relating to the receipt can be properly and efficiently performed.

Furthermore, the information processing apparatus of the present invention is such that the information processing apparatus further includes a slip information acquiring unit that performs image recognition processing on the receipt image received by the receipt image receiving unit, thereby acquiring slip information of the receipt image, and accumulates the acquired slip information in the slip information record associated with the receipt image, generated by the record generating unit.

With this configuration, slip information can be automatically acquired from a receipt image by the image recognition processing, and the slip information can be properly and efficiently input.

Furthermore, the information processing apparatus of the present invention is such that the information processing apparatus further includes a journal information storage unit in which journal information, which is information obtained by journalizing a transaction shown in the receipt image, is stored; and a journal information acquiring unit that acquires information regarding a purchase indicated by the receipt shown in the receipt image, from information acquired by the slip information acquiring unit performing image recognition processing on the receipt image, acquires information of an account title corresponding to the purchase, acquires journal information having the information of the account title, using the information regarding the purchase, and accumulates the journal information in the journal information storage unit.

With this configuration, journal information can be easily acquired from a receipt image.

Furthermore, the information processing apparatus of the present invention is such that the receipt image receiving unit receives the receipt image and client identifying information, which is information for identifying a client, and the receipt image accumulating unit accumulates the receipt image received by the receipt image receiving unit in association with the client identifying information received by the receipt image receiving unit, in the receipt image storage unit.

With this configuration, receipt images can be managed for each client. Accordingly, for example, slip information can be acquired for each client.

Furthermore, the information processing apparatus of the present invention is such that the record generating unit performs image recognition processing on the receipt image received by the receipt image receiving unit, detects at least one purchase contained in the receipt image, automatically generates a slip information record for each detected purchase, and accumulates the slip information record in the slip information storage unit.

With this configuration, a receipt image of a receipt containing multiple purchases also can be processed.

Furthermore, the information processing apparatus of the present invention is such that the receipt image accumulating unit acquires a receipt image, for each receipt, from the receipt image containing images of multiple receipts received by the receipt image receiving unit, and accumulates each receipt image in the receipt image storage unit, and the record generating unit generates a slip information record, for each receipt image acquired for the receipts by the receipt image accumulating unit from the receipt image containing the images of the multiple receipts received by the receipt image receiving unit.

With this configuration, a receipt image containing images of multiple receipts can be used as a receipt image that is to be transmitted to the information processing apparatus. Accordingly, the amount of operation that generates receipt images can be reduced, and the client's workload can be reduced.

The information processing apparatus and the like according to the present invention can properly manage information relating to receipts.

### BRIEF DESCRIPTION OF DRAWINGS

FIG. 1 is a block diagram of an accounting system in an example of the present invention.

FIG. 2 is a flowchart illustrating an operation of an information processing apparatus in the example.

FIG. 3 is a conceptual diagram of the accounting system in the example.

FIG. 4 is a view showing a receipt image in the example.

FIG. 5 is a view showing regions of receipts in the example.

FIG. 6 is a table showing receipt image management information in the example.

FIG. 7 is a view showing text data in the example.

FIG. 8 is a table showing an example of slip information management information in the example.

FIG. 9 is a table showing slip information records in the example.

FIG. 10 is a table showing journal information management information in the example.

FIG. 11 is a table showing Dr. account title management information in the example.

FIG. 12 is a table showing journal information in the example.

FIG. 13 is a view showing text data in the example.

FIG. 14 is a table showing slip information management information in the example.

FIG. 15 is a table showing journal information in the example.

FIG. 16 is a table showing slip information management information in the example.

FIG. 17 is a table showing journal information management information in the example.

FIG. 18 is a view showing a display example in the example.

FIG. 19 is a view showing a display example in the example.

FIG. 20 is a schematic view showing an exemplary appearance of a computer for realizing the information processing apparatus and the like in the example.

FIG. 21 is a diagram showing the internal configuration of the computer system in the example.

### DETAILED DESCRIPTION

Hereinafter, examples of an information processing apparatus and the like will be described with reference to the drawings. Note that constituent elements denoted by the same reference numerals perform the same operations in the examples, and, thus, a description thereof may not be repeated.

### Example

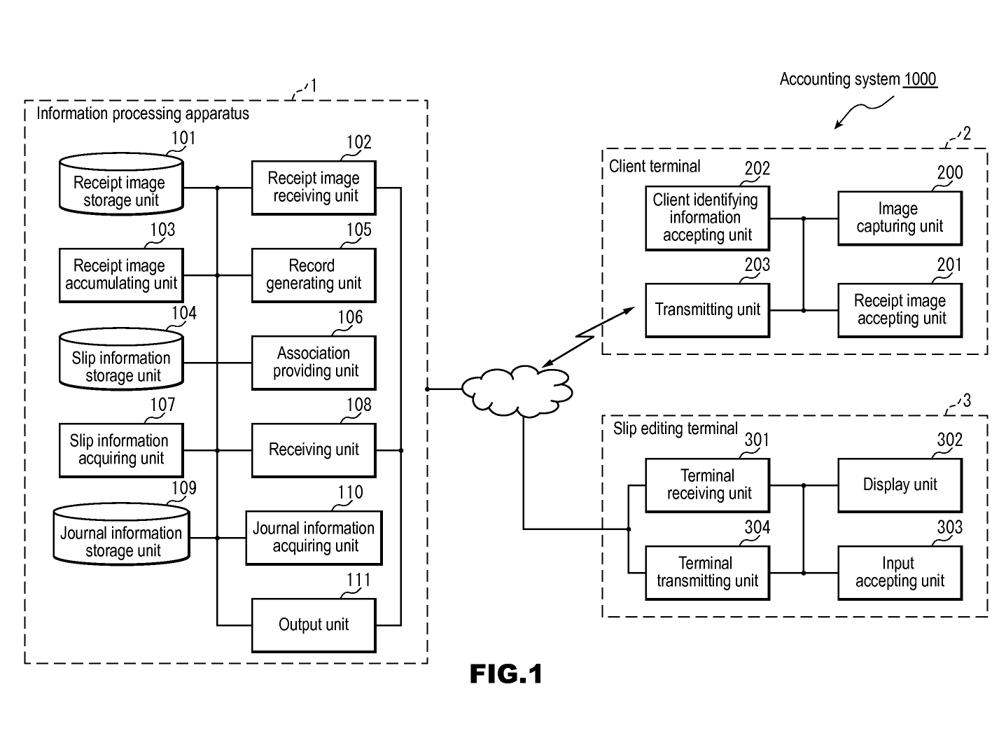

FIG. 1 is a block diagram of an accounting system 1000 in this example.

The accounting system 1000 includes an information processing apparatus 1, one or more client terminals 2, and one or more slip editing terminals 3. The information processing apparatus 1, the one or more client terminals 2, and the one or more slip editing terminals 3 are connected to each other via a network or a communication line such that information can be transmitted therebetween. For the sake of convenience of this description, FIG. 1 shows a case as an example in which the number of client terminals 2 is one, but the number of client terminals 2 may be multiple. The same is applied to the slip editing terminals 3.

The information processing apparatus 1 includes a receipt image storage unit 101, a receipt image receiving unit 102, a receipt image accumulating unit 103, a slip information storage unit 104, a record generating unit 105, an association providing unit 106, a slip information acquiring unit 107, a receiving unit 108, a journal information storage unit 109, a journal information acquiring unit 110, and an output unit 111.

The client terminal 2 includes a receipt image accepting unit 201, a client identifying information accepting unit 202, and a transmitting unit 203.

The slip editing terminal 3 includes a terminal receiving unit 301, a display unit 302, an input accepting unit 303, and a terminal transmitting unit 304.

The information processing apparatus 1 is, for example, a server apparatus. The information processing apparatus 1 may be realized, for example, by a computer or the like.

In the receipt image storage unit 101, one or at least two receipt images, which are images of receipts, are stored. One receipt image typically constitutes one image file. The receipt is, for example, writing that can be a proof of money transfer. The receipt may be writing containing the word “receipt”, writing containing the word “account statement”, “debit statement”, “received”, or “paid”, or the like. A so-called receipt issued at a cash register also may be considered as a receipt. A counterfoil of a receipt in this example substantially may be considered as a receipt. A transaction screen on the web, a printed material of an email, and the like containing this sort of word also may be considered as a receipt. Tickets such as traffic tickets, admission tickets, and boarding tickets, and stubs thereof also may be considered as a receipt. A payment statement of a credit card or the like also may be considered as a receipt. Typically, a receipt contains information such as date, amount of money, unit price, quantity, payee's name, payer's name (name of the party to which the receipt is issued), and the like. The receipt is, for example, a physical medium such as paper on which this sort of information is printed or written with a pen or the like. The receipt image is an image obtained by capturing an image of the receipt with a digital camera or the like, or an image obtained by scanning the receipt with a scanner or the like. The receipt image may be a screenshot of a screen corresponding to the receipt of a transaction performed on the web, an electronic document including the content corresponding to the receipt, or the like. The receipt image may be an image obtained by capturing an image of a ticket such as a traffic ticket as described above or a stub thereof. The receipt preferably satisfies the requirements as a receipt as defined in Japanese tax laws, but does not absolutely have to satisfy the requirements.

The receipt image may be a color image or may be a grey scale image or a monochrome image. If the receipt image is a color image or a grey scale image, there is no limitation on the number of gradations (the number of bits) of the receipt image. The receipt image has preferably a high resolution, such as 200 dpi or more, but may have a low resolution, such as 200 ppi or less. Note that the receipt preferably has a resolution that allows the contents to be read by the naked eye, or a resolution that allows the characters to be recognized by the optical character recognition (OCR). The receipt image is more preferably an image that satisfies the requirements as defined in Japanese National Tax Agency notification of Finance Ministry ordinance, specifically an image having a resolution of at least 200 dpi and at least 24-bit color (256 gradations, i.e., each RGB color having 8 bits).

One receipt image stored in the receipt image storage unit 101 typically contains only an image of one receipt, but may contain images of multiple receipts. One receipt may contain information indicating that multiple purchases were bought. The purchase is, for example, information indicating a product or a service that was bought. For example, one or at least two pieces of information indicating purchases are written on the receipt. The information indicating a purchase is, for example, identifying information of a product or a service that was purchased (e.g., a product name or a service name), or information indicating the content, the type, the category, or the like of such a product or service.

The receipt image storage unit 101 is preferably a non-volatile storage medium, but may be realized also by a volatile storage medium.

The receipt image receiving unit 102 receives the receipt image. For example, the receipt image receiving unit 102 receives the receipt image transmitted from the client terminal 2. One receipt image received by the receipt image receiving unit 102 may contain images of multiple receipts.

Furthermore, for example, the receipt image receiving unit 102 may receive the receipt image and client identifying information, which is information for identifying a client, from the client terminal 2 or the like. The client identifying information may be any information as long as a client can be identified, and examples thereof include a client name, code allocated to a client such as a company number, and the like. The client identifying information may be a client's e-mail address, a client's telephone number, a facsimile number or the like.

Furthermore, for example, the receipt image receiving unit 102 may have information designating the type of slip information record that is to be acquired by the record generating unit 105 (described later) from the received receipt image. The slip information record and the like will be described later.

The receipt image receiving unit 102 may receive the receipt image and the client identifying information transmitted via any means. For example, the receipt image receiving unit 102 may receive the receipt image and the client identifying information transmitted using a protocol such as HTTP or FTP via the Internet or the like. The receipt image receiving unit 102 may receive the receipt image and the client identifying information attached to an email or the like. The receipt image receiving unit 102 may receive the receipt image and the client identifying information transmitted by facsimile or the like. If the receipt image receiving unit 102 receives the receipt image transmitted by an email, facsimile, or the like, the receipt image receiving unit 102 may acquire, as the client identifying information, an e-mail address of the transmission source attached to the received receipt image, a facsimile number of the transmission source, or the like.

The receipt image receiving unit 102 is realized typically by a wireless or wired communication part, but may be realized also by a broadcast receiving part. The receipt image receiving unit 102 may be considered to include or not to include a communication device.

The receipt image accumulating unit 103 accumulates the receipt image received by the receipt image receiving unit 102, in the receipt image storage unit 101. If the receipt image receiving unit 102 receives the receipt image and the client identifying information, the receipt image accumulating unit 103 may accumulate the receipt image received by the receipt image receiving unit 102 in association with the client identifying information received by the receipt image receiving unit 102, in the receipt image storage unit 101 or a storage unit such as an unshown storage medium. The receipt image accumulating unit 103 may accumulate the received receipt image and the like, for example, after providing them with image identifying information, receipt identifying information, and the like. These pieces of identifying information are, for example, identifying information generated according to a predesignated rule (e.g., rule providing ascending serial numbers, etc.).

Furthermore, if one receipt image received by the receipt image receiving unit 102 contains images of multiple receipts, the receipt image accumulating unit 103 may acquire a receipt image, for each receipt, from the receipt image containing the images of the multiple receipts received by the receipt image receiving unit 102, and accumulate the acquired multiple receipt images in the receipt image storage unit 101. For example, the receipt image accumulating unit 103 may extract an image, for each receipt, from the receipt image containing the images of the multiple receipts, and accumulate the extracted receipt images. The technique for detecting respective regions or the like of multiple writing images, from one image containing the multiple writing images, and acquiring images of the detected regions is a known art as the scanner technique or the like, and, thus, a detailed description thereof has been omitted.

The receipt image accumulating unit 103 may be realized typically by an MPU, a memory, or the like. Typically, the processing procedure of the receipt image accumulating unit 103 is realized by software, and the software is stored in a storage medium such as a ROM. Note that the receipt image accumulating unit 103 may be realized also by hardware (a dedicated circuit).

In the slip information storage unit 104, one or at least two slip information records are stored. The slip information record is a record in which slip information can be stored. The slip information record may have one or at least two items in which one or at least two values contained in the slip information can be stored.

The slip information that can be stored in at least one or at least two slip information records stored in the slip information storage unit 104 is information of a slip relating to a receipt image. The information of a slip relating to a receipt image may be considered as information of a slip relating to a receipt shown in the receipt image. The information of a slip relating to a receipt image is, for example, information of a slip containing information written on a receipt shown in the receipt image.

The slip information record stored in the slip information storage unit 104 may be any record in which the slip information can be stored. In the record, the slip information may be stored, or may not be stored. Instead of a value of the slip information, a default value or the like indicating that there is no value may be stored. The slip information record may be considered as an empty record in which the slip information can be stored, or a container in which the slip information can be stored.

The slip information is information that is to be input to a slip. The slip is a piece of paper having a certain format in which money transfer, transaction content, or the like is to be written, in a corporation such as a company or the like. For example, the slip clarifies responsibilities relating to a transaction, and can be taken as a proof for future reference. Examples of the slip include those for various purposes, such as credit slip, debit slip, transfer slip, purchase slip, sales slip, accounting slip, ordering slip, contract slip, inventory management slip, work management slip, warranty, and the like. The information of a slip relating to a receipt image may be considered as information of a slip relating to a receipt shown in the receipt image. For example, the information of a slip relating to a receipt image is information of a slip generated based on a receipt shown in the receipt image, such as information of a debit slip or the like.

The slip information storage unit 104 is preferably a non-volatile storage medium, but may be realized also by a volatile storage medium.

The record generating unit 105 automatically generates a slip information record in which slip information corresponding to the receipt image received by the receipt image receiving unit 102 can be stored, and accumulates the automatically generated slip information record in the slip information storage unit 104. The record is preferably a record in a database such as a relational database, but there is no limitation on the data structure. The record may be considered as a group of one or at least two data sets. For example, the record generating unit 105 may automatically generate an empty slip record in which no slip information is stored. The record generating unit 105 may automatically generate a slip record in which the value of items, of the slip information, where information written on the receipt is to be input, is empty. Alternatively, the record generating unit 105 may automatically generate a slip record in which a default value is stored instead of making the item value empty. The item may be referred to as a field, an attribute, or the like. Automatically generating a slip information record may be considered as newly generating a slip information record.

For example, the record generating unit 105 generates a slip information record, for each of the one or at least two receipts shown in the receipt image. For example, if one receipt image received by the receipt image receiving unit 102 shows only one receipt, one slip information record is generated for this receipt image.

Furthermore, if one receipt image received by the receipt image receiving unit 102 shows multiple receipts, the record generating unit 105 generates a slip information record, for each receipt image acquired for the receipts by the receipt image accumulating unit 103 from the receipt image containing the images of the multiple receipts received by the receipt image receiving unit 102. Alternatively, a slip information record is generated for each receipt region detected for the receipts by the receipt image accumulating unit 103.

Furthermore, for example, the record generating unit 105 generates a slip information record, for each of the one or at least two purchases shown in the receipt image. For example, if each of the one or at least two receipts shown in the receipt image received by the receipt image receiving unit 102 shows multiple purchases, a slip information record is generated for each purchase of each receipt.

Specifically, for example, the record generating unit 105 performs image recognition processing on the receipt image received by the receipt image receiving unit 102, and detects one or at least two purchases contained in the receipt image. Then, the record generating unit 105 automatically generates a slip information record for each detected purchase, and accumulates it in the slip information storage unit 104. The receipt image received by the receipt image receiving unit 102 in this case may be considered, for example, as a receipt image acquired by the receipt image accumulating unit 103 from the receipt image received by the receipt image receiving unit 102. The image processing is, for example, optical character recognition (OCR). The record generating unit 105 detects a purchase, for example, by performing a search using a cue phrase or the like or pattern matching, from character strings acquired by performing the OCR on the receipt image. The record generating unit 105 may adjust, for example, the inclination or the brightness of the receipt image before performing the OCR and the like. The adjusting the inclination or the brightness of an image is a known art as the scanner technique or the like, and, thus, a detailed description thereof has been omitted.

The detecting a purchase may be, for example, detecting information indicating one or at least two purchases (e.g., purchase identifying information such as a purchase name). The detecting a purchase may be detecting information specifying one or at least two purchases. For example, the record generating unit 105 may detect a character string indicating the amount of money (e.g., a numeric string starting from the mark “¥” or a numeric string ending with “yen”, etc.) from the character strings acquired by performing the OCR on the receipt image, and may detect, as each purchase, each line containing the character string indicating the amount of money. For example, if three lines including character strings indicating the amounts of money are detected, it may be considered that three purchases are detected. In this case, the detected character strings indicating the amounts of money may be considered as the amounts of money corresponding to the respective purchases. Alternatively, for example, a character string arranged before, and separated with a space or the like from, a character string indicating the amount of money, in a line containing the character string indicating the amount of money may be detected as information indicating a purchase. By generating a slip information record for each detected line, the record generating unit 105 can generate a slip information record for each purchase in one receipt.

The type of slip information record that is to be generated by the record generating unit 105 may be designated, for example, by the information or the like received by the receipt image receiving unit 102 described above. The type of slip information record may be considered as the type of slip information that can be stored in the slip information record. The type of slip information record is, for example, a slip information record of a sales slip, a slip information record of a debit slip, or the like. The record generating unit 105 may generate two or more types of slip information records for one receipt image.

There is no limitation on a time when the record generating unit 105 generates a slip information record, for example. For example, the record generating unit 105 generates a slip information record for a receipt image, when the receipt image receiving unit 102 receives the receipt image, or before or after the receipt image accumulating unit 103 accumulates the receipt image.

The record generating unit 105 may be realized typically by an MPU, a memory, or the like. Typically, the processing procedure of the record generating unit 105 is realized by software, and the software is stored in a storage medium such as a ROM. Note that the record generating unit 105 may be realized also by hardware (a dedicated circuit).

The association providing unit 106 associates the receipt image stored in the receipt image storage unit 101, with a slip information record in which slip information relating to this receipt image can be stored. The associating the receipt image with the slip information record is, for example, accumulating information in which a pointer of the slip information record and a pointer of the corresponding receipt image are managed in association with each other, in the receipt image storage unit 101 or the slip information storage unit 104. For example, the associating is accumulating information or the like for managing association in which the receipt image (or identifying information of the receipt image) and identifying information of the slip information record associated with this receipt image are taken as information of one record, in the receipt image storage unit 101 or the slip information storage unit 104. The associating the receipt image with the slip information record is, for example, providing the slip information record with a pointer of the corresponding receipt image, or providing a record for managing the receipt image, with a pointer of the corresponding slip information record. The associating the receipt image with the slip information record may be accumulating, as a value (a field value, an attribute value) of one item or the like of the slip information record, the corresponding receipt image or identifying information thereof, or may be accumulating, as a value of one item of a record for managing the receipt image, identifying information of the corresponding slip information record. Giving the receipt image accumulating unit 103 an instruction to accumulate the receipt image, in a predesignated item of the slip information record associated with this receipt image may be considered as the associating the receipt image with the slip information record.

The association providing unit 106 may automatically associate the receipt image with the slip information record. For example, the association providing unit 106 may associate the slip information record generated by the record generating unit 105 for the receipt image received by the receipt image receiving unit 102, with the receipt image corresponding to this slip information record, stored in the receipt image storage unit 101 (i.e., the receipt image received by the receipt image receiving unit 102 described above). Note that the receipt image and the slip information may be manually associated with each other according to an instruction of a client or the like accepted by an unshown accepting unit or the like.

Furthermore, for example, the association providing unit 106 may associate each receipt image acquired and accumulated for multiple receipts by the receipt image accumulating unit 103 from a receipt image containing images of the receipts, with each slip information record generated for that receipt image by the record generating unit 105.

Furthermore, for example, the association providing unit 106 may associate each slip information record generated by the record generating unit 105 for each of one or at least two purchases detected from one receipt image, with that one receipt image stored in the receipt image storage unit 101.

Furthermore, for example, the association providing unit 106 may associate a receipt image containing images of multiple receipts accumulated by the receipt image accumulating unit 103, with each slip information record generated by the record generating unit 105 for each of the multiple receipts shown in the receipt image.

Furthermore, the association providing unit 106 may manually associate the receipt image with the slip information record generated by the record generating unit 105 for that receipt image, according to an instruction or the like from the outside such as the client terminal 2 or the slip editing terminal 3 received by the receiving unit 108 (described later).

The association providing unit 106 may be realized typically by an MPU, a memory, or the like. Typically, the processing procedure of the association providing unit 106 is realized by software, and the software is stored in a storage medium such as a ROM. Note that the association providing unit 106 may be realized also by hardware (a dedicated circuit).

The slip information acquiring unit 107 performs image recognition processing on the receipt image received by the receipt image receiving unit 102, and acquires slip information for this receipt image, using a result of the image recognition processing. The acquired slip information is accumulated in the slip information record associated with this receipt image, generated by the record generating unit 105. The slip information for the receipt image may be considered as slip information for a receipt shown in the receipt image. The image recognition processing performed by the slip information acquiring unit 107 is, for example, OCR on characters shown in the receipt image. The image recognition processing may be processes that acquire the color or the shape of the receipt image. The image recognition processing may be a combination of two or more of these processes. The image recognition processing may be a process that reads barcode shown in the receipt image, for example.

For example, the slip information acquiring unit 107 acquires one or at least two pieces of information forming the slip information, such as date, purchase, quantity, unit price, amount of money, payee's name, payer's name (name of the party to which the receipt is issued), or the like, from the information acquired by performing the image processing on the receipt image. For example, the slip information acquiring unit 107 acquires one or at least two pieces of information forming the slip information, such as date, information indicating a purchase, amount of money, payee's name, payer's name (name of the party to which the receipt is issued), or the like, for example, using a cue phrase, from data (text data) of the character strings acquired by performing the OCR on the receipt image. For example, the slip information acquiring unit 107 acquires, as information of date, a character string following the character string “date”, in a line containing this character string “date” from among the character strings obtained by the OCR. For example, the slip information acquiring unit 107 detects a numeric string starting from the mark “¥” or a numeric string ending with “yen”, from the character strings obtained by the OCR, and acquires the detected numeric string, as the amount of money (the amount of money received). For example, the slip information acquiring unit 107 acquires, as a purchase, a character string arranged before a character string containing the amount of money, in the same line as this character string containing the amount of money. The information indicating a purchase may be considered, for example, as information that is to be input to an item called “abstract” of a slip. The slip information acquiring unit 107 may acquire, as information indicating a purchase, a character string arranged after the character string “Note: as”. The slip information acquiring unit 107 may acquire, as a payer's name, a character string other than “To:”, in a line containing the character string “To:”. The payer's name may be considered as a name of the party to which the receipt is issued. The slip information acquiring unit 107 may acquire, as a payee's name, a character string other than the payer's name, in a line containing the character string “Company”.

A matching process between the result of recognition of the shape or the color of a receipt and the shape or the color stored in advance in an unshown storage medium or the like may be performed, and, if the matching rate is a predesignated threshold value or more, information of a purchase corresponding to the shape stored in advance may be acquired. For example, in advance, the shape or the color of a traffic ticket of a bus, a train, or the like and the information “bus”, “train”, or the like, which is information indicating a purchase, are accumulated in association with each other in an unshown storage medium or the like. Then, the slip information acquiring unit 107 performs, for example, a matching process that judges whether or not the shape or the color of a receipt image matches the shape or the color associated in advance with “train”, which is information indicating a purchase. If the matching rate is a predesignated threshold value or more, the information “train” may be acquired as a purchase corresponding to this receipt image. Note that, in order to judge whether or not the shapes or the colors match each other, it is possible to compare characteristic amounts or the like of the shapes or the colors. The image matching process and the like are known arts, and, thus, a detailed description thereof has been omitted.

Furthermore, if barcode associated with the payee's name is written on a receipt shown in the receipt image, the barcode may be read from the receipt image and the payee's name indicated by the barcode may be acquired. The process that reads information associated with barcode and the like are known arts, and, thus, a detailed description thereof has been omitted.

Furthermore, the slip information acquiring unit 107 may acquire an account title corresponding to a purchase, from the information indicating the purchase acquired by the image recognition processing, by performing processing similar to that of the journal information acquiring unit 110 (described later), and accumulate this account title as information of one item of the slip information, in the slip information record.

This process that acquires slip information is merely an example, and the slip information acquiring unit 107 may acquire information forming the slip information through any processing.

If multiple purchases are contained in one receipt image, for example, for each purchase, slip information in which information such as the date or the payee's name acquired from the one receipt image is combined with information indicating that purchase, the amount of money corresponding to that purchase, and the like may be acquired and accumulated in the corresponding purchase record.

The slip information acquiring unit 107 accumulates the thus acquired slip information, for example, in a slip information record in which the values of one or at least two items are empty or default values, generated by the record generating unit 105. In the case of accumulating the slip information in a purchase record in which information is already stored, the information stored in the purchase record may be overwritten or replaced by the slip information.

The slip information acquiring unit 107 may acquire the information forming the slip information, received by the receiving unit 108 (described later) from the slip editing terminal 3 (described later) or the like, and accumulate it in the slip information record. In this case, information or the like for designating a slip information record in which the slip information is to be accumulated may be further received, and the slip information may be accumulated in the slip information record designated by this information.

Furthermore, the receiving unit 108 receives part of slip information for a slip information record in which slip information is already stored, from the slip editing terminal 3 or the like, and the slip information acquiring unit 107 acquires the part of slip information. Then, the slip information acquiring unit 107 may overwrite or replace part of the existing slip information record, using this acquired part of slip information. The accumulating the slip information in this case may be considered as editing the slip information record.

Furthermore, if an instruction or the like to delete part of slip information for a slip information record in which slip information is already stored is received by the receiving unit 108, the slip information acquiring unit 107 may delete information corresponding to the part of slip information received by the receiving unit 108, from the existing slip information record. The deleting the slip information in this case may be considered as editing the slip information record.

The slip information acquiring unit 107 may be realized typically by an MPU, a memory, or the like. Typically, the processing procedure of the slip information acquiring unit 107 is realized by software, and the software is stored in a storage medium such as a ROM. Note that it may be realized also by hardware (a dedicated circuit).

The receiving unit 108 receives an instruction to request transmission of the receipt image stored in the receipt image accumulating unit 103 and the slip information record associated with this receipt image. The receiving unit 108 receives such an instruction to request the transmission, for example, from the slip editing terminal 3 (described later) or the like.

Furthermore, the receiving unit 108 may receive information for editing the slip information record. For example, the receiving unit 108 may receive information that is to be newly accumulated with the slip information in the slip information record, or information for giving an instruction to update or delete the slip information accumulated in the slip information record. For example, the receiving unit 108 receives one or at least two pieces of information forming the slip information that are to be accumulated in the slip information record, from the slip editing terminal 3 (described later) or the like. the receiving unit 108 may accept an instruction to accumulate the information forming the slip information, in the slip information record. The receiving unit 108 may accept information designating the slip information record in which the information forming the slip information is to be accumulated. The information forming the slip information received by the receiving unit 108 may be part of the slip information. If information for editing is accepted, for example, the slip information acquiring unit 107 or the like described above accumulates information forming the slip information, in the designated slip information record.

Furthermore, the receiving unit 108 may receive, in a similar manner described above, information for requesting transmission of journal information, or one or at least two pieces of information forming journal information for editing the journal information, from the slip editing terminal 3 (described later) or the like. The journal information will be described later. The journal information may be edited, for example, by the journal information acquiring unit 110 using the one or at least two pieces of information forming journal information, in a manner similar to that of the slip information acquiring unit 107.

The receiving unit 108 may receive information for requesting transmission of, for example, interface screen information (not shown) for the receipt image receiving unit 102 to receive a receipt image, from the client terminal 2 (described later) or the like.

The receiving unit 108 is realized typically by a wireless or wired communication part, but may be realized also by a broadcast receiving part. The receiving unit 108 may be considered to include or not to include a communication device.

In the journal information storage unit 109, journal information, which is information obtained by journalizing a transaction shown in the receipt image, is stored. The transaction shown in the receipt image is a transaction shown on a receipt shown in the receipt image. Alternatively, it may be a transaction corresponding to each of one or at least two purchases contained in the receipt. The journalizing is classifying a transaction into Cr. and Dr. account titles. Specifically, a transaction shown in the receipt image is classified into a Dr. entry and a Cr. entry, the account title and the amount of money corresponding to each entry are determined, and a result of the determination is stored. The journal information is information obtained by journalizing a transaction shown in the receipt image. For example, it is information having the account title and the amount of money of a Dr. entry, and the account title and the amount of money of a Cr. entry, corresponding to a purchase shown in the receipt image described above. The account title contained in the journal information is information indicating an account title, such as a name of the account title, code indicating the account title, or the like. The journal information has information of the account title and the amount of money of Dr. and the account title and the amount of money of Cr., for example. The account title is also referred to as a corresponding title. The journal information may have information such as date (e.g., date contained in the slip information corresponding to the journal information). The journal information may further have, as data of one item of the journal information, attribute information (e.g., a name of a division such as a department or a section, etc.) indicating the position to which a client who transmitted the receipt image belongs in the company, for example. The journal information may have a sub title or the like indicating the breakdown of the account title.

The journal information storage unit 109 is preferably a non-volatile storage medium, but may be realized also by a volatile storage medium.

The journal information acquiring unit 110 acquires information regarding a purchase indicated by the receipt shown in the receipt image received by the receipt image receiving unit 102, from the information acquired by the slip information acquiring unit 107 performing the image recognition processing on the receipt image. Then, the journal information acquiring unit 110 acquires information of an account title corresponding to the purchase, acquires journal information having the information of the account title, using the information regarding the purchase, and accumulates it in the journal information storage unit 109. For example, the information acquired by the slip information acquiring unit 107 performing the image recognition processing may be text information or the like obtained as a result of the OCR, or may be slip information as described above. The information regarding the purchase is, for example, the information indicating the purchase shown in the receipt image, the amount of money corresponding to the purchase (e.g., the amount of money paid for buying the purchase), the payer's name (name of the party to which the receipt is issued), the date, or the like. For example, the journal information acquiring unit 110 acquires the information indicating the purchase, from the information acquired by the slip information acquiring unit 107 performing the image recognition processing. Then, the journal information acquiring unit 107 acquires, by performing a search, an account title corresponding to the acquired information indicating the purchase, from multiple pieces of information in which pieces of information indicating purchases and account titles are associated with each other, accumulated in advance in an unshown storage medium or the like. The journal information acquiring unit 110 preferably acquires both of a Dr. account title and a Cr. account title, but may acquire only one of them. Since the journal information acquired for a receipt is typically such that the Cr. account title is “cash”, the value “cash” may be acquired by default as the value of the Cr. account title. The information in which pieces of information indicating purchases and account titles are associated with each other is, for example, information having the information indicating the purchase “gasoline expense” and the account title “travel and transportation expenses”, or information having the information indicating the purchase “ball-point pen” and the account title “supplies expense”.

Instead of the multiple pieces of information in which pieces of information indicating purchases and account titles are associated with each other, multiple pieces of information in which pieces of information indicating purchases and Dr. account titles are associated with each other and multiple pieces of information in which pieces of information indicating purchases and Cr. account titles are associated with each other may be prepared in advance. These pieces of information may be used to acquire both of a Dr. account title and a Cr. account title corresponding to the acquired information indicating the purchase from a result of the image recognition processing. For example, the journal information acquiring unit 110 acquires the amount of money contained in the information acquired by the slip information acquiring unit 107 performing the image recognition processing, as the amount of money corresponding to a Dr. account title and the amount of money corresponding to a Cr. account title. The journal information acquiring unit 110 accumulates the journal information having the acquired Dr. account title and the amount of money thereof and the acquired Cr. account title and the amount of money thereof, in the journal information storage unit 109. As the journal information, it is also possible to accumulate journal information further having information such as date contained in the information acquired by the slip information acquiring unit 107 performing the image recognition processing.

Furthermore, for example, the receipt image receiving unit 102 receives user attribute information as well as the above-described client identifying information, and accumulates this attribute information in association with the receipt image in the receipt image storage unit 101 or in an unshown storage medium or the like. When the journal information acquiring unit 110 acquires journal information from one piece of slip information, attribute information corresponding to the receipt image corresponding to the slip information may be read, and journal information having this attribute information may be accumulated in the journal information storage unit 109. Alternatively, multiple pieces of information in which pieces of client identifying information and pieces of attribute information are associated with each other may be accumulated in an unshown storage medium or the like, and attribute information corresponding to the client identifying information corresponding to one piece of slip information may be acquired by performing a search from the pieces of information, and journal information having this attribute information may be accumulated in the journal information storage unit 109.

The journal information acquiring unit 110 may be realized typically by an MPU, a memory, or the like. Typically, the processing procedure of the journal information acquiring unit 110 is realized by software, and the software is stored in a storage medium such as a ROM. Note that the journal information acquiring unit 110 may be realized also by hardware (a dedicated circuit).

The output unit 111 outputs one or at least two receipt images stored in the receipt image storage unit 101 and the slip information records associated with the respective receipt images, stored in the slip information storage unit 104. The receipt images and the slip information records do not have to be simultaneously output. For example, in response to information for requesting transmission of one or at least two receipt images and the slip information records associated with the receipt images, accepted by the receiving unit 108, the requested receipt images and the slip information records associated with the receipt images are transmitted to the slip editing terminal 3 or other apparatus from which this request information was given. For example, the output unit 111 may output the receipt image and the slip information record arranged in a template or the like prepared in advance according to the type of slip information record or the like. The information output by the output unit 111 may contain information of an input interface screen for accepting the information of one or at least two items of the slip information, for the slip information record that is to be output. The output unit 111 may output only one of the receipt image and the slip information record.

The output unit 111 may transmit, for example, interface screen information (not shown) for the receipt image receiving unit 102 to receive a receipt image, to the client terminal 2 or the like from which the information for requesting transmission of these pieces of information, received by the receiving unit 108, was given.

Furthermore, as in the case of the receipt image or the like described above, the output unit 111 may output the journal information stored in the journal information storage unit 109, an input interface screen for accepting an instruction to edit (e.g., information for inputting or deleting, etc.) the journal information, or the like, to the slip editing terminal 3 or the like.

The output is typically transmission to an external apparatus, but may be display on a display screen, projection using a projector, printing in a printer, accumulation in a storage medium, delivery of a processing result to another processing apparatus or another program, or the like.

The output unit 111 may be considered to include or not to include a communication part or an output device such as a display screen. The output unit 111 may be realized, for example, by driver software for an output device, a combination of driver software for an output device and the output device, or the like.

The client terminal 2 is, for example, an information processing terminal such as a computer, a portable information communication terminal such as a portable telephone, a so-called smartphone, or a tablet terminal, or the like. The client terminal 2 preferably has a camera or the like, or can be connected to a scanner or the like.

An image capturing unit 200 captures images of one or at least two receipts, thereby acquiring receipt images. The image capturing unit 200 may be considered to include or not to include, for example, an image capturing device such as a camera, a scanner, or the like. The image capturing unit 200 may be realized, for example, by driver software for an image capturing device, a combination of driver software for an image capturing device and the image capturing device, or the like.

The receipt image accepting unit 201 accepts a receipt image. The accepting is, for example, accepting a receipt image output by another processing unit, receiving a receipt image transmitted from another apparatus, reading a receipt image accumulated in a storage medium, or the like. Hereinafter, a case will be described as an example in which the receipt image accepting unit 201 accepts the receipt image acquired by the image capturing unit 200. If the receipt image accepting unit 201 does not accept the receipt image acquired by the image capturing unit 200, the image capturing unit 200 may be omitted.

The receipt image accepting unit 201 may be considered to include or not to include devices such as an input part that accepts input of a receipt image, a receiving part that receives a receipt image, or a reading part that reads a receipt image form a storage medium or the like. The receipt image accepting unit 201 may be realized, for example, by a device driver for an input part, a device driver for a receiving part, a device driver for a reading part, or the like.

The client identifying information accepting unit 202 accepts client identifying information. The client identifying information is, for example, a client name, a client code, an employee number, an e-mail address, a telephone number, or the like. The client identifying information accepting unit 202 accepts the client identifying information of a client who transmitted a receipt image. The accepting the client identifying information may be reading a user ID (user account, etc.) input at the time of logging in to the client terminal 2. The client identifying information accepting unit 202 may further accept client attribute information. The client attribute information may constitute part of the client identifying information, and, in this case, it may be considered that accepting the client identifying information also means accepting the client attribute information. The client identifying information may be input through any means such as a numeric keypad, a keyboard, a mouse, a menu screen, or the like. The client identifying information accepting unit 202 may be realized by a device driver for an input part such as a numeric keypad or a keyboard, control software for a menu screen, or the like.

The transmitting unit 203 transmits the receipt image accepted by the receipt image accepting unit 201, to the information processing apparatus 1. For example, the transmitting unit 203 transmits the receipt image in association with the client identifying information, or the client identifying information and the attribute information, accepted by the client identifying information accepting unit 202, to the information processing apparatus 1.

The transmitting unit 203 is realized typically by a wireless or wired communication part, but may be realized also by a broadcasting part. The transmitting unit 203 may be considered to include or not to include a communication device.

The client terminal 2 may include an accepting unit (not shown) that accepts information for requesting transmission of interface screen information for transmitting a receipt image, or a receiving unit (not shown) that receives an interface screen for transmitting a receipt image transmitted from the information processing apparatus 1. The client terminal 2 may include a display unit (not shown) that displays the interface screen, or a transmission instruction accepting unit (not shown) that accepts an instruction to transmit a receipt image or the like, for example. In this case, for example, in response to accepting the information for requesting transmission, the transmitting unit 203 transmits information for requesting transmission of the interface screen, to the information processing apparatus 1.

The slip editing terminal 3 is, for example, a terminal used by a user who generates a slip, such as a tax accountant or an accountant. The slip editing terminal 3 is, for example, an information processing terminal such as a computer, a portable information communication terminal such as a portable telephone, a so-called smartphone, or a tablet terminal, or the like.

The terminal receiving unit 301 receives one or at least two receipt images transmitted from the information processing apparatus 1, and slip information records associated with the receipt images. The information that is received may further contain information of an input interface screen for accepting the information of one or at least two items of the slip information, for the slip information records.

Furthermore, the terminal receiving unit 301 may receive the journal information transmitted from the information processing apparatus 1.

The terminal receiving unit 301 is realized typically by a wireless or wired communication part, but may be realized also by a broadcast receiving part. The terminal receiving unit 301 may be considered to include or not to include a communication device.

The display unit 302 displays, on a display device such as a monitor, the one or at least two receipt images received by the terminal receiving unit 301 and the slip information records associated with the receipt images. The display unit 302 may be considered to include or not to include the display device. The display unit 302 may be realized, for example, by driver software for a display device, a combination of driver software for a display device and the display device, or the like.

The input accepting unit 303 accepts input of information forming at least part of the slip information. For example, the input accepting unit 303 accepts input of information accumulated as at least part of the slip information records displayed by the display unit 302. The information that is accepted may be considered, for example, as information forming at least part of the slip information corresponding to the receipt images displayed by the display unit 302.

The information may be input through any means such as a numeric keypad, a keyboard, a mouse, a menu screen, or the like. The input accepting unit 303 may be realized by a device driver for an input part such as a numeric keypad or a keyboard, control software for a menu screen, or the like.

The terminal transmitting unit 304 transmits the information forming at least part of the slip information accepted by the input accepting unit 303, to the information processing apparatus 1. The terminal transmitting unit 304 may further transmit information designating the slip information record in which this information is to be stored, an instruction to accumulate this information in the slip information record, or the like, to the information processing apparatus 1.

The terminal transmitting unit 304 is realized typically by a wireless or wired communication part, but may be realized also by a broadcasting part. The terminal transmitting unit 304 may be considered to include or not to include a communication device.

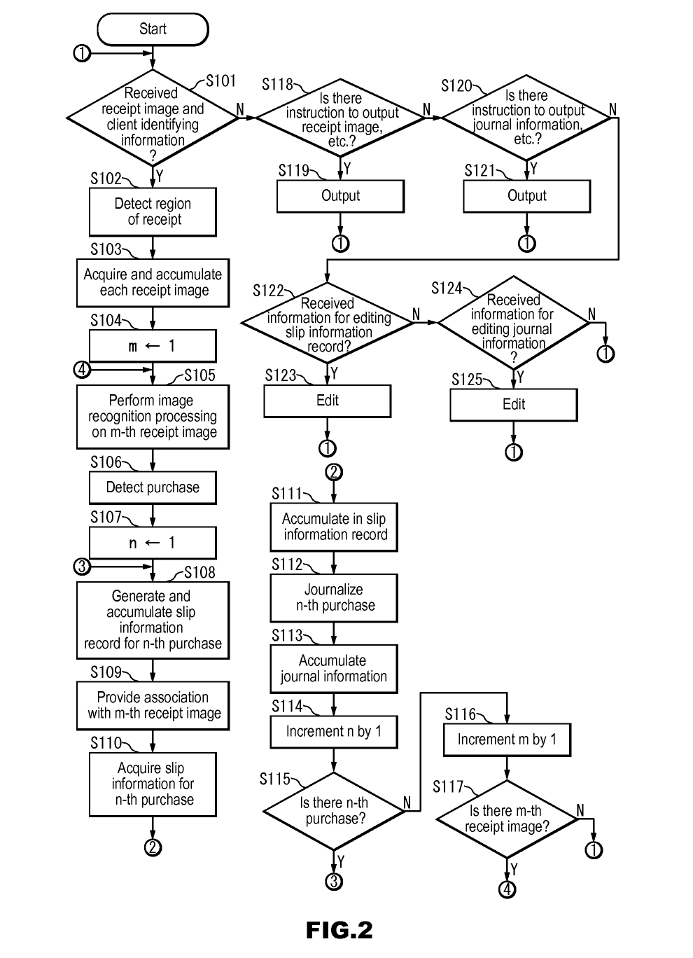

Next, an operation of the information processing apparatus 1 of the accounting system 1000 will be described with reference to the flowchart in FIG. 2.

(Step S101) It is judged whether or not the receipt image receiving unit 102 has received a receipt image and client identifying information. The receipt image receiving unit 102 may further receive, in addition to the above, client attribute information (e.g., information of a name of the division to which the client belongs, etc.). If received, the procedure advances to step S102, and, if not, the procedure advances to step S118.

(Step S102) The receipt image accumulating unit 103 detects one or at least two regions for respective receipts, from the receipt image accepted in step S101.

(Step S103) The receipt image accumulating unit 103 acquires, as a receipt image, an image of a region of each receipt detected in step S102, and accumulates it in association with the client identifying information or the attribute information accepted in step S101 in the receipt image storage unit 101. The acquired each receipt image may be accumulated in association with identifying information such as a file name generated according to a predesignated rule or the like.

(Step S104) The record generating unit 105 substitutes 1 for a counter m.

(Step S105) The record generating unit 105 reads an m-th receipt image from among the receipt images accumulated in step S103, and performs image recognition processing on this receipt image. For example, the record generating unit 105 performs the OCR.

(Step S106) The record generating unit 105 detects one or at least two purchases in the receipt shown in the receipt image, using a result of the image recognition processing on the receipt image in step S105. For example, a cue phrase, a character arrangement pattern, or the like is detected from the character strings acquired by the OCR, so that information indicating one or at least two purchases or information capable of specifying each purchase (e.g., amount of money corresponding to each purchase, etc.) is detected.

(Step S107) The record generating unit 105 substitutes 1 for a counter n.

(Step S108) The record generating unit 105 generates a slip information record for an 1st purchase from among the purchases detected in step S106. For example, a record is generated in which the values of one or at least two items where the content acquired from the receipt is to be input are empty. Then, the record generating unit 105 accumulates the generated slip information record, in the slip information storage unit 104.

(Step S109) The association providing unit 106 associates the m-th receipt image with the slip information record acquired in step S108 immediately before. For example, the association providing unit 106 may accumulate the identifying information of the m-th receipt image (e.g., file name) as data of one item of the slip information record, or may accumulate management information in which the identifying information of the m-th receipt image and the identifying information provided for the slip information record acquired in step S108 immediately before are associated with each other, in the receipt image storage unit 101, the slip information storage unit 104, an unshown storage medium, or the like.

(Step S110) The slip information acquiring unit 107 acquires slip information for the m-th purchase. For example, the slip information acquiring unit 107 acquires predesignated information forming slip information such as information indicating the m-th purchase, the amount of money thereof, or the date, from the result of the image recognition processing performed in step S105. Note that information designating the type of information that is to be acquired as the information forming the slip information may be, for example, accumulated in advance in an unshown storage medium or the like. Information of an item that cannot be acquired may be left empty or as a default value or the like.

(Step S111) The slip information acquiring unit 107 accumulates the slip information acquired in step S110, in the slip information record acquired in step S108 immediately before.

(Step S112) The journal information acquiring unit 110 journalizes the m-th purchase, thereby acquiring journal information. For example, the journal information acquiring unit 110 acquires information indicating the m-th purchase from the result of the image recognition processing performed in step S105, and acquires, by performing a search or the like, a Dr. account title corresponding to the information indicating the m-th purchase, from information in which purchases and Dr. account titles are associated with each other. The journal information acquiring unit 110 acquires a predesignated account title “cash” as the Cr. account title. For example, the journal information acquiring unit 110 acquires an amount of money corresponding to the m-th purchase, as the amount of money corresponding to the Dr. and Cr. account titles, from the result of the image recognition processing performed in step S105. In this manner, the journal information acquiring unit 110 acquires journal information having the Dr. account title and the amount of money thereof, and the Dr. account title and the amount of money thereof. The journal information acquiring unit 110 may acquire the attribute information accepted in step S101, as the attribute information of the journal information.

(Step S113) The journal information acquiring unit 110 accumulates the journal information acquired in step S112, in the journal information storage unit 109.

(Step S114) The record generating unit 105 increments the counter n by 1.

(Step S115) The record generating unit 105 judges whether or not there is an n-th purchase in the purchases detected in step S106. If there is, the procedure returns to step S108, and, if not, the procedure advances to step S116.

(Step S116) The record generating unit 105 increments the counter m by 1.

(Step S117) The record generating unit 105 judges whether or not there is an m-th receipt image in the receipt images accumulated in step S103. If there is, the procedure returns to step S105, and, if not, the procedure returns to step S101.

(Step S118) It is judged whether or not the receiving unit 108 has received information indicating an instruction to output the one or at least two receipt images and the slip information records associated with the receipt images. It may be further judged whether or not the receiving unit 108 has received information containing information designating the client identifying information. If received, the procedure advances to step S119, and, if not, the procedure advances to step S120.

(Step S119) The output unit 111 outputs the one or at least two receipt images and the slip information records associated with the receipt images in response to the instruction received in step S118. If the instruction received in step S118 contains the client identifying information, the one or at least two receipt images associated with the client identifying information and the slip information records associated with the receipt images may be output. The output may be transmission to the slip editing terminal 3 or the like, may be transmission to another apparatus, or may be accumulation in an unshown storage medium (e.g., portable storage medium) or the like. The procedure returns to step S101.

(Step S120) It is judged whether or not the receiving unit 108 has received information indicating an instruction to output the journal information. If received, the procedure advances to step S121, and, if not, the procedure advances to step S122.

(Step S121) The output unit 111 outputs the journal information stored in the journal information storage unit 109 in response to the instruction received in step S120. The output may be transmission to the slip editing terminal 3 or the like, may be transmission to another apparatus, or may be accumulation in an unshown storage medium (e.g., portable storage medium) or the like. The procedure returns to step S101.

(Step S122) It is judged whether or not the receiving unit 108 has received information for editing the slip information record. If received, the procedure advances to step S122, and, if not, the procedure advances to step S123S124.

(Step S123) The slip information acquiring unit 107 edits the slip information record, using the information for editing the slip information record received in step S122. For example, the slip information acquiring unit 107 reads and edits the edit information record that is to be edited, and overwrites the record before the edition stored in the slip information storage unit 104 with the slip information record after the edition. The procedure returns to step S101.

(Step S124) It is judged whether or not the receiving unit 108 has received information for editing the journal information. If received, the procedure advances to step S125, and, if not, the procedure returns to step S101.

(Step S125) The journal information acquiring unit 110 edits the journal information, using the information for editing the journal information received in step S124. For example, the journal information acquiring unit 110 reads and edits the journal information (e.g., one journal information record, etc.) that is to be edited, and overwrites the journal information before the edition stored in the journal information storage unit 109 with the journal information after the edition. The procedure returns to step S101.

Note that the procedure is terminated by powering off or an interruption at completion of the process in the flowchart in FIG. 2.

Hereinafter, an operation of the client terminal 2 will be briefly described as an example. For example, if the image capturing unit 200 captures an image of at least one receipt, thereby acquiring a receipt image, the receipt image accepting unit 201 accepts the receipt image acquired by the image capturing unit 200. The client identifying information accepting unit 202 accepts the client identifying information of a client who transmitted the receipt image. The transmitting unit 203 transmits the receipt image accepted by the receipt image accepting unit 201 and the client identifying information accepted by the client identifying information accepting unit 202, to the information processing apparatus 1. The client identifying information accepting unit 202 may accept the client attribute information, as well as the client identifying information.

Hereinafter, an operation of the slip editing terminal 3 will be briefly described as an example. For example, if the input accepting unit 303 accepts an instruction or the like to request transmission of a receipt image and the slip information record associated with this receipt image stored in the information processing apparatus 1, the terminal transmitting unit 304 transmits information for requesting transmission of this receipt image and the slip information record associated with the receipt image, to the information processing apparatus 1. The terminal receiving unit 301 receives the receipt image and the slip information record transmitted from the information processing apparatus 1 in response to the request information, and the display unit 302 displays the received receipt image and slip information record, on a monitor or the like. If the user who viewed the displayed receipt image inputs information for editing the slip information record, the input accepting unit 303 accepts the input information, and the terminal transmitting unit 304 transmits information for editing the slip information record (e.g., edit instruction, or information that is to be stored by editing, etc.) to the information processing apparatus 1.

Furthermore, if the input accepting unit 303 accepts an instruction or the like to request transmission of the journal information stored in the information processing apparatus 1, the terminal transmitting unit 304 transmits information for requesting transmission of this journal information, to the information processing apparatus 1. The terminal receiving unit 301 receives the journal information transmitted from the information processing apparatus 1 in response to the request information, and the display unit 302 displays the received journal information, on a monitor or the like. If the user who viewed the displayed journal information inputs information for editing the journal information, the input accepting unit 303 accepts the input information, and the terminal transmitting unit 304 transmits information for editing the journal information (e.g., edit instruction, or information that is to be stored by editing, etc.) to the information processing apparatus 1.

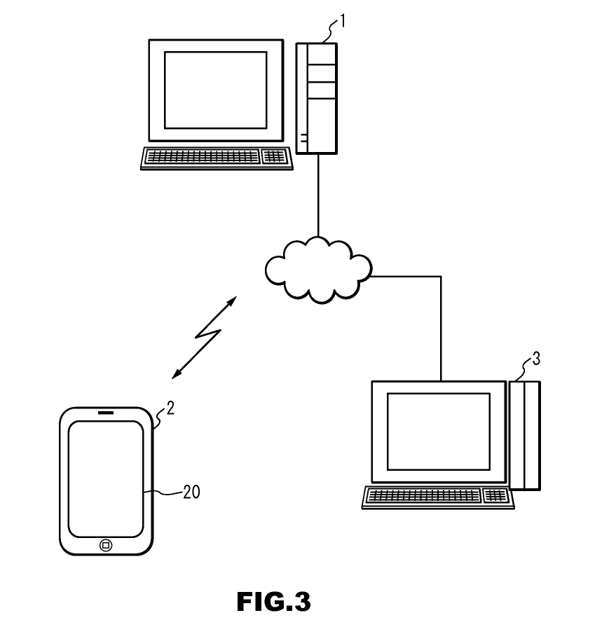

Hereinafter, a specific operation of the accounting system 1000 in this example will be described. FIG. 3 shows a conceptual diagram of the accounting system 1000. Below, a case will be described as an example in which the information processing apparatus 1 is a server apparatus, the client terminal 2 is an information communication terminal called smartphone, and the slip editing terminal 3 is a computer, which are connected to each other via a wired or wireless network such as the Internet, for example. Although FIG. 3 shows a case in which the number of client terminals 2 is one, there may be multiple client terminals 2. The same is applied to the slip editing terminal 3. It is assumed that the image capturing unit 200 of the client terminal 2 has a digital camera (not shown) as an image capturing device. It is assumed that the client terminal 2 includes a monitor 20 as a display device, and a display unit (not shown) or the like for displaying various menu screens, interface screens, or the like on the monitor 20.

First, if a client A of the client terminal 2 displays an input interface or the like on the monitor 20, and inputs the client A's client identifying information “12001” and the client A's attribute information “First Sales Dep.” (i.e., the name of the division to which the client A belongs), the client identifying information accepting unit 202 accepts the input client identifying information “12001” and attribute information “First Sales Dep.”.

Next, if the client A captures images of two receipts arranged side by side, using the digital camera of the client terminal 2, the image capturing unit 200 acquires one receipt image containing the images of the two receipts captured by the digital camera.

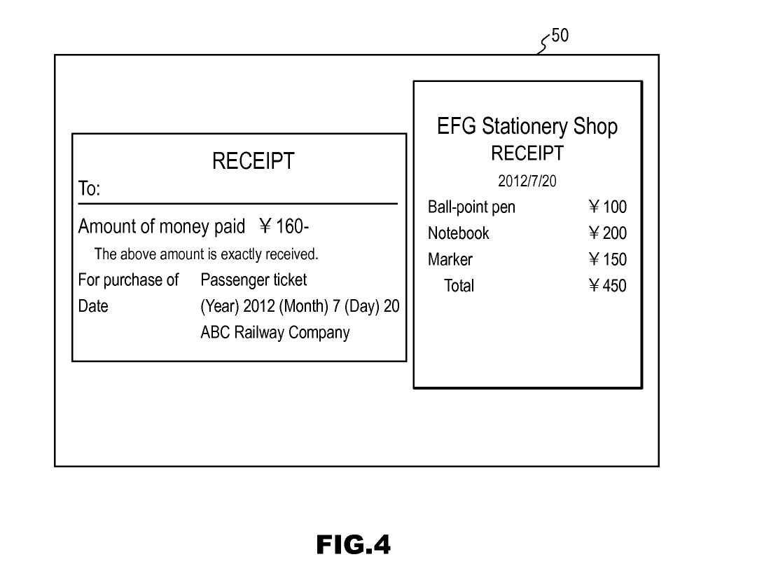

FIG. 4 is a view showing a receipt image 50 acquired by the image capturing unit 200.

If an instruction to designate the receipt image acquired by the image capturing unit 200 as a receipt image that is to be transmitted to the information processing apparatus 1 is given from the client A via an unshown accepting unit or the like to the client terminal 2, the receipt image accepting unit 201 accepts the receipt image shown in FIG. 4, acquired by the image capturing unit 200.

It is assumed that an instruction to transmit the receipt image accepted by the receipt image accepting unit 201 to the information processing apparatus 1 of the company to which the client A belongs is given from the client A via an unshown accepting unit or the like to the client terminal 2. The transmitting unit 203 transmits the receipt image shown in FIG. 4, accepted by the receipt image accepting unit 201, and the client identifying information “12001” and the attribute information “First Sales Dep.” accepted by the client identifying information accepting unit 202, to the information processing apparatus 1.

The receipt image receiving unit 102 receives the receipt image shown in FIG. 4 and the client identifying information “12001” and the attribute information “First Sales Dep.” transmitted from the client terminal 2.

The receipt image accumulating unit 103 detects one or more receipt regions, from the receipt image received by the receipt image receiving unit 102. For example, the receipt image accumulating unit 103 detects a background image in the receipt image based on a difference between the brightnesses or the like of pixels forming the receipt image, and detects one or more regions surrounded by the background image.

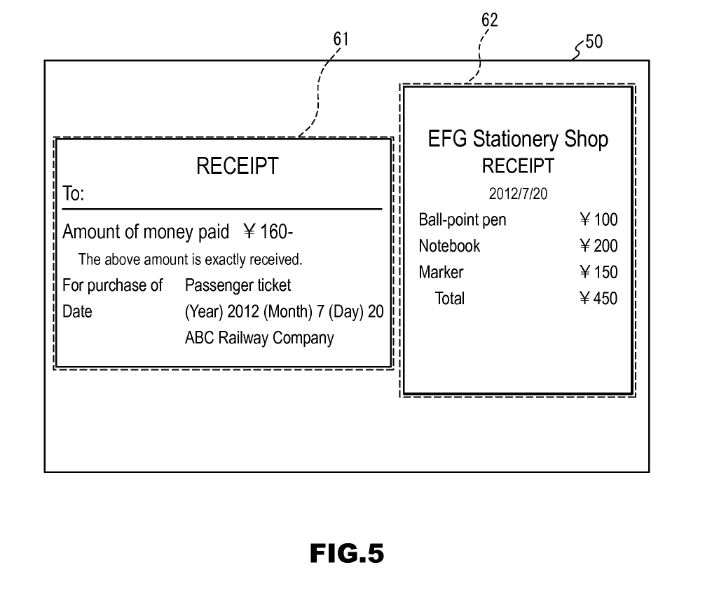

FIG. 5 is a view showing one or more receipt regions detected by the receipt image accumulating unit 103. In this drawing, a region 61 and a region 62 indicated by the dotted lines show two regions detected as receipt regions.

The receipt image accumulating unit 103 extracts an image of each receipt region detected in FIG. 5, and accumulates each extracted image as a receipt image in association with the received client identifying information “12001” and attribute information “First Sales Dep.” described above in the receipt image storage unit 101. The receipt image accumulating unit 103 provides each receipt image that is accumulated, with a file name according to a predesignated rule. The predesignated rule is, for example, a rule that provides a file name in which the date of accumulation and the two-digit serial number indicating the order of accumulation are combined. It is assumed that the date of accumulation is “July 23”. This date is acquired, for example, from an unshown clock or the like. For example, the receipt image corresponding to the region 61 in FIG. 5 is provided with the file name “072301” and the receipt image corresponding to the region 62 is provided with the file name “072302”, and the images are accumulated in the receipt image storage unit 101. In this example, the date of accumulation is also accumulated in association with the receipt images.

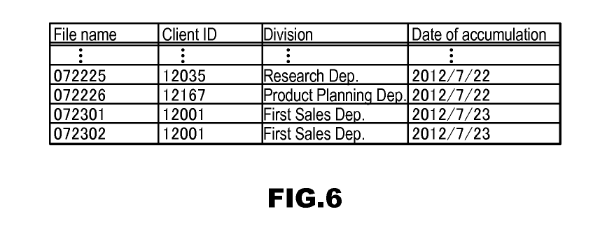

FIG. 6 is a table showing receipt image management information for managing association between the receipt images stored in the receipt image storage unit 101, the client identifying information, and the attribute information. The receipt image management information is stored, for example, in the receipt image storage unit 101. The receipt image management information has the items “file name”, “client ID”, “division”, and “date of accumulation”. In the table, “file name” is a file name of “receipt image”, “client ID” is the client identifying information received by the receipt image receiving unit 102, and “division” is the attribute information received by the receipt image receiving unit 102. It is assumed that receipt images other than the above are already stored in the receipt image storage unit 101, and are managed in the receipt image management information. Further, “date of accumulation” indicates a date at which the receipt image was accumulated.

The record generating unit 105 reads, from the receipt image storage unit 101, a first receipt image from among the receipt images that have been acquired by the receipt image accumulating unit 103 from the receipt image received by the receipt image receiving unit 102 and have been accumulated in the receipt image storage unit 101. The receipt images may be read in any order. In this example, the record generating unit 105 reads a receipt image with the file name being “072301” (hereinafter, referred to as a receipt image “072301”, and the same is applied to receipt images with other file names). Then, the record generating unit 105 performs the OCR on the read receipt image “072301”, thereby acquiring text data consisting of the character strings written on the receipt shown in the receipt image “072301”.

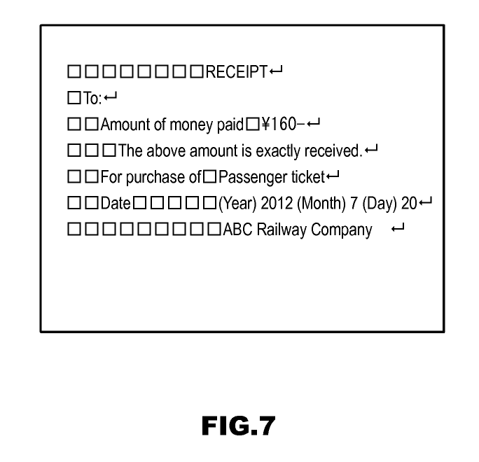

FIG. 7 is a view showing the text data acquired by the record generating unit 105 performing the OCR. In the drawing, the quadrangles indicate spaces.

The record generating unit 105 performs processing that detects a purchase from the text data shown in FIG. 7. In this example, the amount of money associated with each purchase is detected. The record generating unit 105 first detects a numeric string following the yen sign “¥” as the amount of money. In this example, only “160” is detected as a numeric string, and, thus, the record generating unit 105 judges that only one purchase is detected from the receipt image “072301”. Note that a case in which the number of amounts of money detected is multiple will be described later.

Next, the record generating unit 105 generates a slip information record for a first purchase (purchase corresponding to the amount of money “160” detected in the step above) from among the detected purchases.

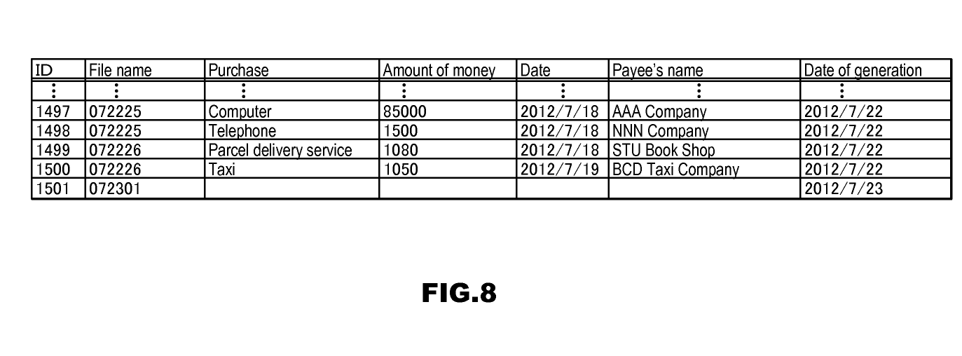

FIG. 8 is a table showing an example of slip information management information for managing the slip information stored in the slip information storage unit 104. In this example, each record (row) of the slip information management information is a slip information record. The slip information management information (i.e., each slip information record) has the items “ID”, “file name”, “purchase”, “amount of money”, “date”, and “payee's name”. In the table, “ID” is identifying information of a slip information record, “file name” is a file name of a receipt image corresponding to the slip information record, “purchase” is information indicating a purchase, “amount of money” is an amount of money corresponding to the purchase, “date” is a date written on a receipt, “payee's name” is a payee's name corresponding to the purchase, and “date of generation” indicates a date at which the record was generated. It is assumed that the record (row) generated by the record generating unit 105 for the first purchase is a record with “ID” being “1501”, and, in the generated record, the values of the items other than “file name” and “date of generation” are empty. It is assumed that “file name” is “072301”, which is a file name of the receipt image for which the slip information record is generated, and “date of generation” is “2012/7/23 (Jul. 23, 2012)”.

Next, the slip information acquiring unit 107 acquires slip information that is to be accumulated in the record with “ID” being “1501”, generated by the record generating unit 105. First, the slip information acquiring unit 107 judges whether or not multiple purchases are detected in the text data obtained by the OCR shown in FIG. 7. In this example, the number of purchases detected is only one as described above, and, thus, the slip information acquiring unit 107 performs processing that detects information indicating the purchase in the entire text data obtained by the OCR.

First, the slip information acquiring unit 107 detects the yen sign “¥”, and acquires a continuous character string arranged before the detected yen sign in the same line. The continuous character string is a character string not punctuated by spacing, newline code, punctuation marks, or the like. In this case, the character string “Amount of money paid” is acquired. Next, it is judged whether or not a character string matching either “amount of money” or “total” is contained in the acquired character string. In this case, a character string matching the character string “amount of money” is contained, and, thus, the slip information acquiring unit 107 judges that the character string “Amount of money paid” is not information indicating a purchase. Accordingly, the slip information acquiring unit 107 searches for the character string “for purchase of”, “purpose of payment”, or “as a”, in the text data obtained by the OCR shown in FIG. 7. In this example, the character string “For purchase of” is detected. Accordingly, the slip information acquiring unit 107 acquires, as information indicating a purchase, continuous one or more character strings separated with a space or the like from a character string containing the detected character string, in the same line as the detected character string. In this example, the character string “Passenger ticket” is acquired as a character string indicating a purchase, from the line containing the character string “For purchase of”, and is accumulated as the value of “purchase” of the record with “ID” being “1501” of the slip information management information shown in FIG. 8.

Furthermore, the slip information acquiring unit 107 acquires the numeric string “160” arranged after the yen sign, from the text data obtained by the OCR shown in FIG. 7, and accumulates it as the value of “amount of money” of the record with “ID” being “1501” of the slip information management information shown in FIG. 8.

The slip information acquiring unit 107 detects a character string consisting of “(Year)” and numbers, “(Month)” and numbers, and “(Day)” and numbers from the text data obtained by the OCR shown in FIG. 7. The slip information acquiring unit 107 accumulates “2012/7/20”, which is a value obtained by joining the numbers contained in the detected character string with “/”, as the value of “date” of the record with “ID” being “1501” of the slip information management information shown in FIG. 8. The slip information acquiring unit 107 detects a character string in which “(Year)” and numbers, “(Month)” and numbers, and “(Day)” and numbers are arranged, from the text data obtained by the OCR shown in FIG. 7. The slip information acquiring unit 107 accumulates “2012/7/20”, which is a value obtained by joining the numbers contained in the detected character string with “/”, as the value of “date” of the record with “ID” being “1501” of the slip information management information shown in FIG. 8.

Furthermore, the slip information acquiring unit 107 detects a character string that is a continuous character string containing a character string such as “Company”, “Shop”, “Corporation”, or the like and that does not start from “To:” or that is not arranged after the characters “To:”, from the text data obtained by the OCR shown in FIG. 7. The slip information acquiring unit 107 accumulates the detected character string “ABC Railway Company”, as the value of “payee's name” of the record with “ID” being “1501” of the slip information management information shown in FIG. 8.

With this processing, the slip information acquiring unit 107 has acquired slip information for the first purchase of the receipt image “072301” and accumulated the acquired slip information in the corresponding slip information record.

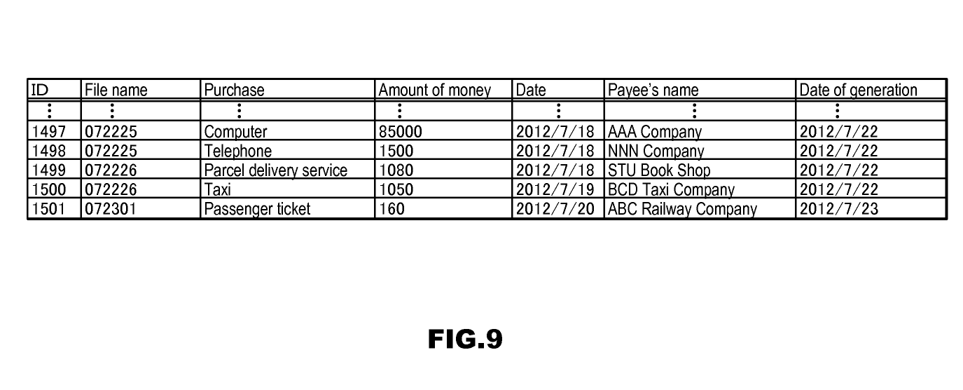

FIG. 9 is a table showing slip information records in which the slip information is accumulated by the slip information acquiring unit 107.

Next, the journal information acquiring unit 110 performs processing that acquires journal information for the first purchase of the receipt image “072301”.

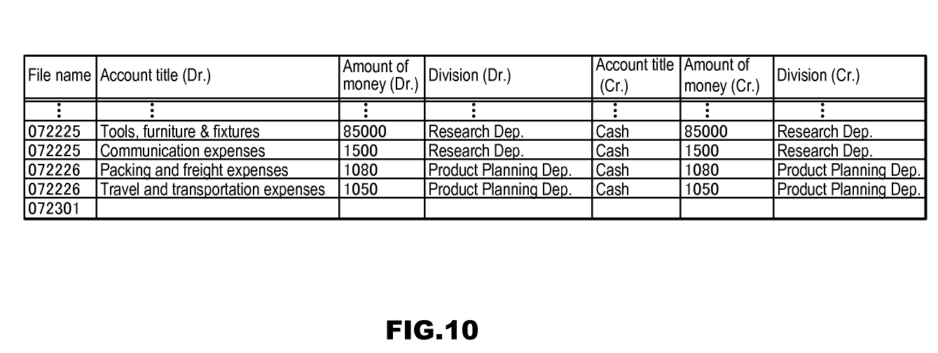

FIG. 10 shows journal information management information for managing the journal information stored in the journal information storage unit 109. The journal information management information has the items “file name”, “account title (Dr.)”, “amount of money (Dr.)”, “division (Dr.)”, “account title (Cr.)”, “amount of money (Cr.)”, and “division (Cr.)”. In the table, “file name” is a file name of a receipt image from which journal information is to be acquired, “account item (Dr.)” is a Dr. account title, “amount of money (Dr.)” is an amount of money corresponding to the Dr. account title, “division (Dr.)” is client attribute information (e.g., a name of a division, in this case) corresponding to the Dr. account title, “account item (Cr.)” is a Cr. account title, “amount of money (Cr.)” is an amount of money corresponding to the Cr. account title, and “division (Cr.)” is client attribute information corresponding to the Cr. account title. It is assumed that other journal information records are already stored.

First, the slip information acquiring unit 107 adds one record (row) to the journal information management information. The record that is added is, for example, a record in which the values of the items other than “file name” are empty. That is to say, a record is added (generated) in which items where information written on a receipt shown in the receipt image is to be input are empty. It is assumed that “file name” is “072301”, which is a file name of the receipt image for which the journal information is to be generated.

Next, the slip information acquiring unit 107 acquires “Passenger ticket”, which is information indicating a purchase, for the first purchase, from the text data obtained by performing the OCR on the receipt image “072301” shown in FIG. 7, by performing processing similar to that of the slip information acquiring unit 107.

Next, the journal information acquiring unit 110 acquires a Dr. account title corresponding to the information indicating the purchase “Passenger ticket”.

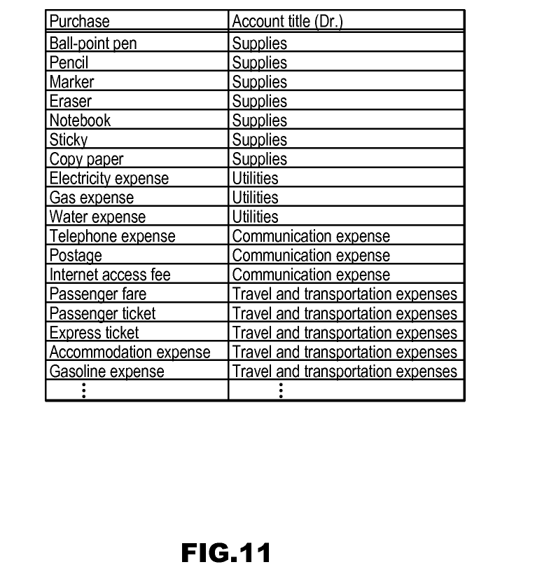

FIG. 11 shows Dr. account title management information for managing association between pieces of information indicating purchases and Dr. account titles. The Dr. account title management information has the items “purchase” and “account title (Dr.)”. In the table, “purchase” is information indicating a purchase, and “account title (Dr.)” is a Dr. account title.

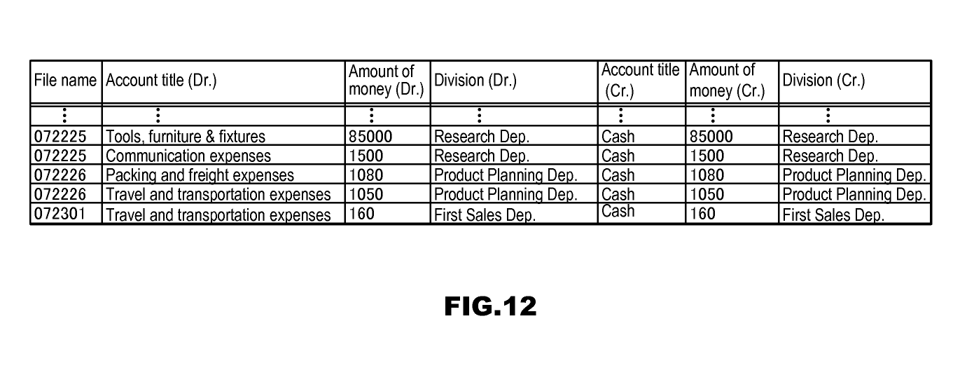

The journal information acquiring unit 110 detects a record (row) with the value of “purchase” matching “Passenger ticket”, from the Dr. account title management information shown in FIG. 11, and acquires the value of “account title (Dr.)” of the detected record, as the value of the Dr. account title. In this example, the value “travel and transportation expenses” is acquired as the value of the Dr. account title. Then, the journal information acquiring unit 110 accumulates the acquired value “travel and transportation expenses” of the Dr. account title, as the value of “account title (Dr.)” of the journal information management information record newly generated in the step above. The journal information acquiring unit 110 accumulates the file name “072301” of the receipt image “072301”, as the value of “file name” of the journal information management information record newly generated in the step above. The journal information acquiring unit 110 accumulates “160”, which is the value of the amount of money acquired by performing processing similar to that of the slip information acquiring unit 107, as the values of “amount of money (Dr.)” and “amount of money (Cr.)”. The journal information acquiring unit 110 accumulates “First Sales Dep.” acquired as the attribute information corresponding to the file name “072301” of the receipt image by performing a search or the like from the receipt image management information shown in FIG. 5, as “division (Dr.)” and “division (Cr.)”. The journal information acquiring unit 110 accumulates “cash” designated by default as the value of “account title (Cr.)”. Accordingly, the journal information record as shown in FIG. 12 is stored in the journal information storage unit 109.

Since the number of purchases detected by the record generating unit 105 from the receipt image “072301” is one, the processing that acquires slip information and journal information from this receipt image “072301” is ended.

Next, the record generating unit 105 reads a receipt image “072302”, which is a second receipt image from among the receipt images that have been acquired by the receipt image accumulating unit 103 from the receipt image received by the receipt image receiving unit 102 and have been accumulated in the receipt image storage unit 101. Then, the record generating unit 105 performs the OCR on the read receipt image “072302”, thereby acquiring text data consisting of the character strings written on the receipt shown in the receipt image “072302”.

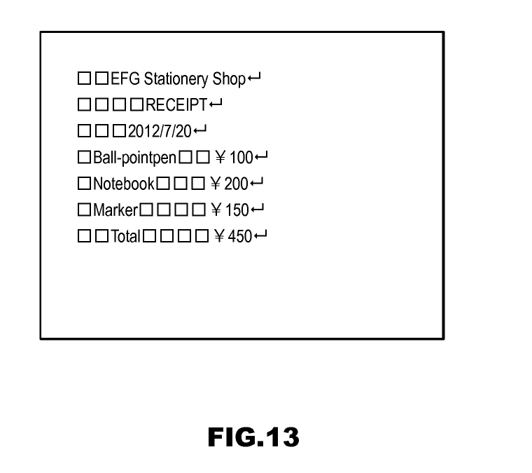

FIG. 13 is a view showing the text data acquired by the record generating unit 105 performing the OCR. In the drawing, the quadrangles indicate spaces.

The record generating unit 105 performs processing that detects a purchase from the text data shown in FIG. 13. In this example, first, a continuous numeric string following the yen sign “¥” is detected. In this example, four numeric strings are detected as the numeric string. Accordingly, the record generating unit 105 detects continuous character strings before the yen signs, and detects a character string that contains none of “total”, “subtotal”, and “total amount”, from among the detected character strings. In this example, three character strings “Ball-point pen”, “Notebook”, and “Marker” are detected as character strings that do not contain the above-described characters. Accordingly, the record generating unit 105 judges that three purchases have been detected from the receipt image “072302”.

Next, the record generating unit 105 generates a slip information record for a first purchase from among the detected three purchases. It is assumed that the first purchase is a purchase corresponding to the character string “Ball-point pen”. The slip information records may be generated for the purchases in any order.

In this example, a record with “ID” being “1502” is newly generated for the slip information management information shown in FIG. 9. It is assumed that, in the generated record, the values of the items other than “file name” and “date of generation” are empty. It is assumed that “file name” is “072302”, which is a file name of the receipt image for which the slip information record is generated, and “date of generation” is “2012/7/23”.

Next, the slip information acquiring unit 107 acquires slip information that is to be accumulated in the record with “ID” being “1502”, generated by the record generating unit 105. First, the slip information acquiring unit 107 judges whether or not multiple purchases are detected in the text data obtained by the OCR shown in FIG. 13. In this example, the number of purchases detected is multiple as described above, and, thus, the slip information acquiring unit 107 acquires slip information for the first purchase.

First, the slip information acquiring unit 107 acquires the character string “Ball-point pen” detected in the step above, as information indicating the first purchase. Then, the slip information acquiring unit 107 accumulates this character string “Ball-point pen”, as the value of “purchase” of the record with “ID” being “1502” generated in the slip information management information.

Next, the slip information acquiring unit 107 detects the yen sign “¥”, from character strings in the same line as “Ball-point pen” detected in the step above in the text data obtained by the OCR shown in FIG. 13. Then, the slip information acquiring unit 107 acquires a continuous numeric string “100” arranged after the detected yen sign, in the same line as this sign, and accumulates it as the value of “amount of money” of the record with “ID” being “1502” generated in the slip information management information.

Next, the slip information acquiring unit 107 acquires the date “2012/7/20” and the payee's name “EFG Stationery Shop” from the text data shown in FIG. 13, by performing processing similar to that on the receipt image “072302” described above. Then, the slip information acquiring unit 107 accumulates them as the values of “date” and “payee's name” of the record with “ID” being “1502” generated in the slip information management information.

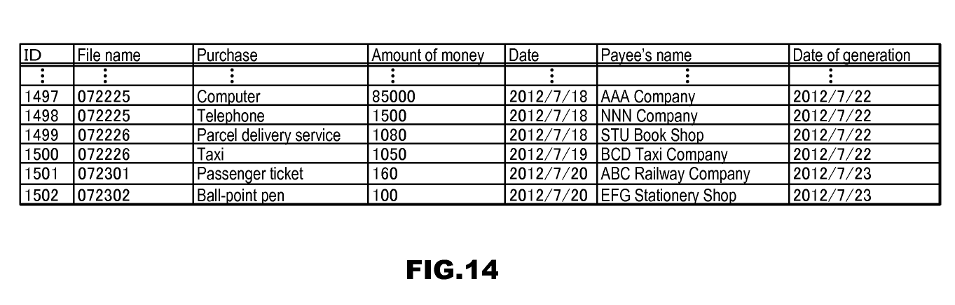

FIG. 14 is a table showing slip information management information to which the slip information record has been added in this manner.

Next, the journal information acquiring unit 110 performs processing that acquires journal information for the first purchase of the receipt image “072302”.

First, the slip information acquiring unit 107 adds one record (row) to the journal information management information. The record that is added is, for example, a record in which the values of the items other than “file name” are empty. It is assumed that “file name” is “072302”, which is a file name of the receipt image for which the journal information is to be generated.

Next, the journal information acquiring unit 110 acquires “Ball-point pen”, which is information indicating the first purchase, in a manner similar to that of the slip information acquiring unit 107.

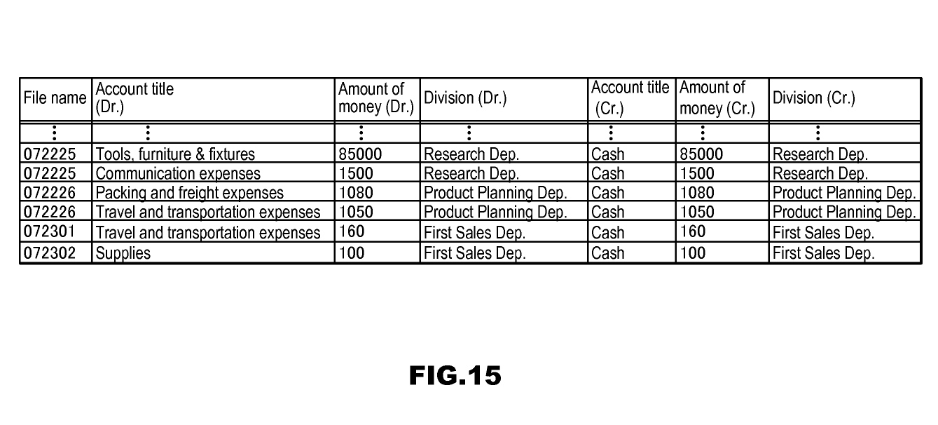

The slip information acquiring unit 107 detects a record (row) with the value of “purchase” matching “Ball-point pen”, from the Dr. account title management information shown in FIG. 11, and acquires the value “consumable” that is the value of “account title (Dr.)” of the detected record, as the value of the Dr. account title. Then, the journal information acquiring unit 110 accumulates the acquired value “consumable” of the Dr. account title, as the value of “account title (Dr.)” of the journal information management information record newly generated in the step above. The journal information acquiring unit 110 accumulates the file name “072302” of the receipt image “072302”, as the value of “file name” of the journal information management information record newly generated in the step above. The journal information acquiring unit 110 accumulates “100”, which is the value of the amount of money acquired by performing processing similar to that of the slip information acquiring unit 107, as the values of “amount of money (Dr.)” and “amount of money (Cr.)”. The journal information acquiring unit 110 accumulates “First Sales Dep.” acquired as the attribute information corresponding to the file name “072302” of the receipt image by performing a search or the like from the receipt image management information shown in FIG. 5, as “division (Dr.)” and “division (Cr.)”. “Cash” designated by default as the value of “account title (Cr.)” is accumulated. Accordingly, the journal information record as shown in FIG. 15 is stored in the journal information storage unit 109.

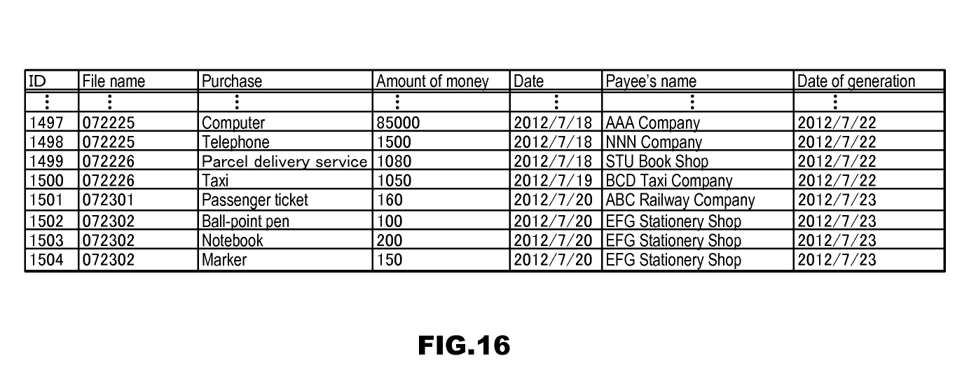

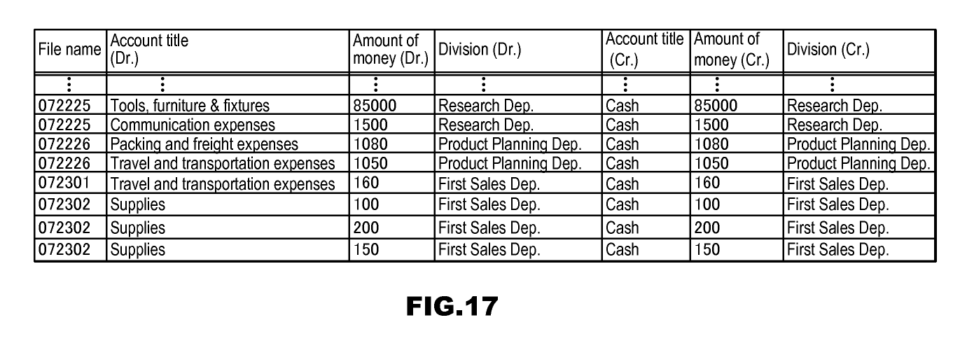

Since the number of purchases detected by the record generating unit 105 from the receipt image “072302” is three, processing that acquires slip information and journal information in a similar manner described above is performed also on a second purchase “Notebook” and a third purchase “Marker”. FIG. 16 is a table showing slip information management information as a result thereof. FIG. 17 is a table showing journal information management information as a result thereof.

In this manner, the processing that automatically acquires slip information and journal information for two receipt images acquired from the receipt image received by the receipt image receiving unit 102 is ended.

For example, it is assumed that an accountant or the like who manages the slip information, the journal information, and the like accumulated in the information processing apparatus 1 inputs an instruction to output a receipt image accumulated on “Jul. 23, 2012” in the information processing apparatus 1 and slip information corresponding to this receipt image, to the input accepting unit 303 of the slip editing terminal 3. Then, it is assumed that this instruction is transmitted from the terminal transmitting unit 304 to the information processing apparatus 1.

If the receiving unit 108 of the information processing apparatus 1 receives the instruction transmitted from the slip editing terminal 3, the output unit 111 detects a record with “date of accumulation” being “2012/7/23” from the receipt image management information shown in FIG. 6. The output unit 111 acquires “072301” and “072302”, which are the values of “file name” contained in the detected records, and reads receipt images indicated by the respective file names from the receipt image storage unit 101. The output unit 111 reads a slip information record with the value of “file name” being “072301” and a slip information record with the value of “file name” being “072302” from the slip information storage unit 104. Then, the output unit 111 arranges each read slip information record together with the receipt image corresponding to the same file name, in a template or the like prepared in advance in an unshown storage medium or the like. Then, the output unit 111 transmits information having each receipt image obtained by the arrangement and the slip information record associated with that receipt image, to the slip editing terminal 3.

If the terminal receiving unit 301 of the slip editing terminal 3 receives information in which the receipt images and the slip information records are arranged in the template, transmitted by the output unit 111 of the information processing apparatus 1, the display unit 302 displays the received information, on a monitor (not shown) or the like.

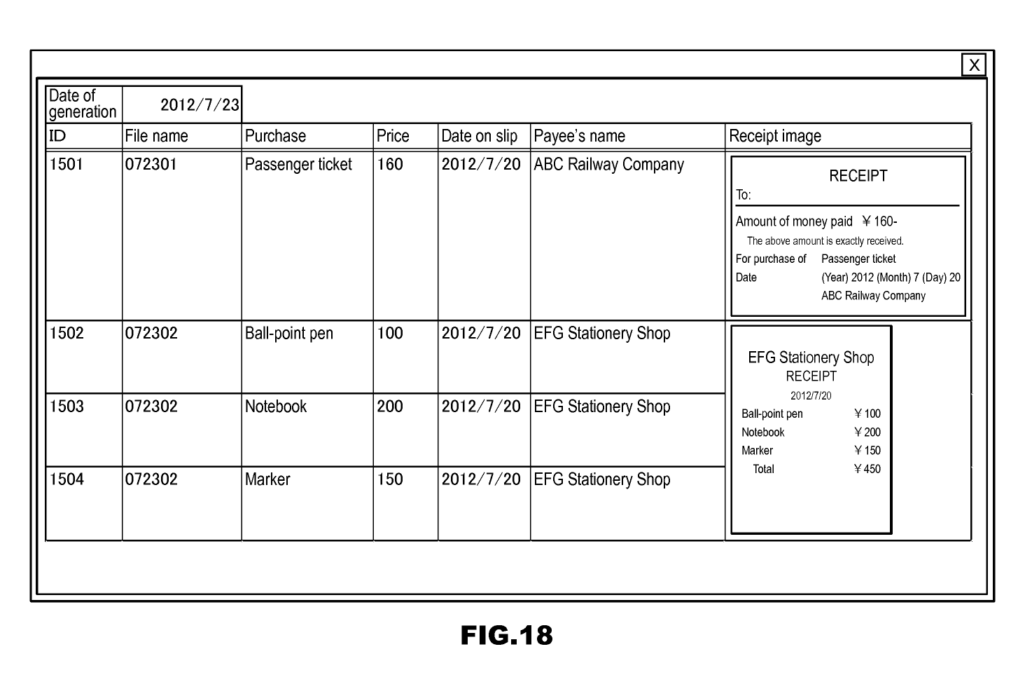

FIG. 18 is a view showing a display example of the receipt images and the slip information records. In this example, the case was described in which both a receipt image and a slip information record are displayed, but the display unit 302 may display only one of the receipt image and the slip information record. The display may be performed by an apparatus other than the slip editing terminal 3. The client identifying information may be further transmitted from the slip editing terminal 3, and only slip information or the like corresponding to the transmitted client identifying information may be output (e.g., transmitted) by the information processing apparatus 1.

For example, it is assumed that the accountant found an error or the like in a slip information record, and performs, using a keyboard or the like, an operation that edits the point where the error was found in the slip information record displayed on the monitor. For example, the accountant overwrites the point where the error was found, with a correct value. The input accepting unit 303 accepts the input value and the like. Then, if an instruction or the like to update the slip information stored in the information processing apparatus 1 with the edited slip information record is input to the slip editing terminal 3, the terminal transmitting unit 304 transmits an edit instruction having the value of “ID” of the edited slip information record, the point where the change was made by the edition (e.g., item name), and the changed value, to the information processing apparatus 1.

If the receiving unit 108 of the information processing apparatus 1 accepts the edited edit instruction transmitted from the terminal transmitting unit 304, the slip information acquiring unit 107 corrects, for example, overwrites the point (e.g., item) indicated by information indicating the point where the change was made, of the slip information record specified with “ID” indicated by this edit instruction, with a value indicated by the changed value. Accordingly, the slip information record can be edited from the slip editing terminal 3. Note that, if there is an empty item or the like in a slip information record, inputting a value to this empty item via a network or the like from the slip editing terminal 3 with reference to the receipt image displayed on the slip editing terminal 3 also may be considered as editing.

For example, it is assumed that the accountant inputs an instruction to output the journal information corresponding to the receipt image with the date being “Jul. 20, 2012”, to the input accepting unit 303 of the slip editing terminal 3, and this instruction is transmitted from the terminal transmitting unit 304 to the information processing apparatus 1.

If the receiving unit 108 of the information processing apparatus 1 receives the instruction transmitted from the slip editing terminal 3, the output unit 111 detects a record with “date” being “2012/7/20” from the journal information management information shown in FIG. 17, and reads the detected journal information record. Then, the output unit 111 arranges the read journal information record in a template or the like prepared in advance in an unshown storage medium or the like, and transmits it to the slip editing terminal 3.

If the terminal receiving unit 301 of the slip editing terminal 3 receives information in which the journal information is arranged in the template, transmitted by the output unit 111 of the information processing apparatus 1, the display unit 302 displays the received information, on a monitor (not shown) or the like.

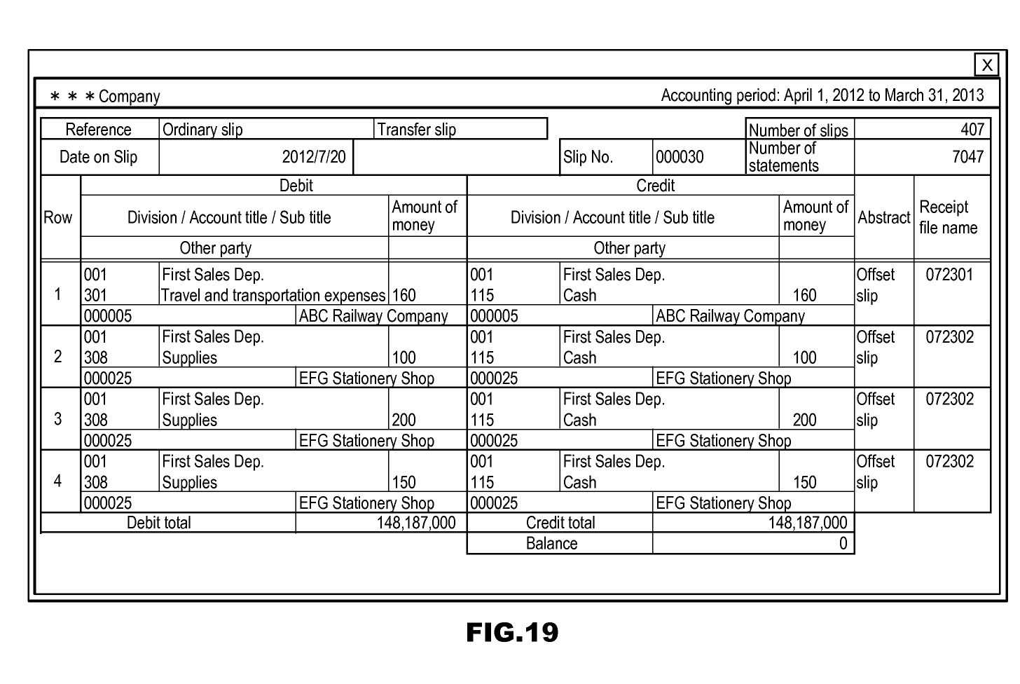

FIG. 19 is a view showing a display example of the journal information. The journal information may be displayed by an apparatus other than the slip editing terminal 3. The client identifying information may be further transmitted from the slip editing terminal 3, and only journal information or the like corresponding to the transmitted client identifying information may be output (e.g., transmitted) by the information processing apparatus 1.

Furthermore, as in the case of a slip information record, the slip editing terminal 3 may accept an operation that edits the displayed journal information, and the slip editing terminal 3 may transmit information for giving an edit instruction containing an edit content, indicated by the edit operation, to the information processing apparatus 1, and the journal information stored in the information processing apparatus 1 may be edited by the information processing apparatus 1 according to the edit content.

As described above, according to this example, if images of receipts are transmitted to the information processing apparatus 1, slip information records are generated. Accordingly, slip input of information relating to the receipts can be properly and efficiently performed, and the information relating to the receipts can be properly managed. For example, slip information for the receipts can be input (edited) from the slip editing terminal 3 with reference to the receipt images corresponding to the records to which this slip information is input. Accordingly, for example, the slip information from the receipts can be easily input by people other than those who submitted the receipts, and, for example, input of the slip information from the receipts can be easily outsourced. The slip information automatically acquired from the receipt images by the image recognition processing can be accumulated in the slip information records associated with the receipt images.

In the foregoing example, each processing (each function) may be realized as integrated processing using a single apparatus (system), or may be realized as distributed processing using multiple apparatuses.

Furthermore, in the foregoing example, it will be appreciated that two or more communication parts (information transmitting units, etc.) in one apparatus may be physically realized by one medium.

Furthermore, in the foregoing example, information relating to the processing performed by each constituent element, for example, information that is to be accepted, acquired, selected, produced, transmitted, or received by each constituent element, information such as a threshold value, a numerical expression, or an address used in each constituent element in the processing and the like may be retained in an unshown storage medium temporarily or for a long period of time even if not specified in the description above. Information may be accumulated in the unshown storage medium by each constituent element or by an unshown accumulating unit. Information may be read from the unshown storage medium by each constituent element or by an unshown reading unit.

The software that realizes the information processing apparatus in the foregoing example may be the following sort of program. Specifically, this program is a program used in a state where a computer can access: a receipt image storage unit in which a receipt image, which is an image of a receipt, is stored; and a slip information storage unit in which a slip information record is stored, the slip information record being a record in which slip information, which is information of a slip relating to the receipt image, is stored; the program causing the computer to function as: a receipt image receiving unit that receives the receipt image; a receipt image accumulating unit that accumulates the receipt image received by the receipt image receiving unit, in the receipt image storage unit; and an association providing unit that associates the receipt image stored in the receipt image storage unit, with the slip information record in which the slip information relating to that receipt image is to be stored.

Furthermore, in the program, the functions realized by the program do not include functions that can be realized only by hardware. For example, functions that can be realized only by hardware, such as a modem or an interface card, in an acquiring unit that acquires information or an output unit that outputs information are not included in the functions realized by the above-described program.

Furthermore, the computer that executes this program may be a single computer, or may be multiple computers. That is to say, integrated processing may be performed, or distributed processing may be performed.

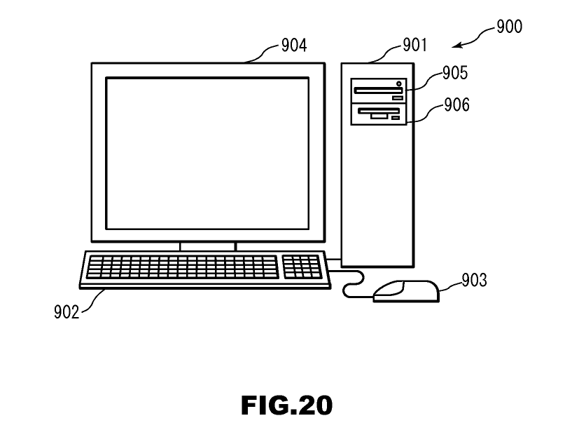

FIG. 20 is a schematic view showing an exemplary appearance of a computer that executes the program described above to realize the information processing apparatus, the client terminal 2, and the slip editing terminal 3 in the foregoing example. The foregoing example may be realized using computer hardware and computer programs executed thereon.

In FIG. 20, a computer system 900 is provided with a computer 901 including a compact disk read only memory (CD-ROM) drive 905 and a Floppy (registered trademark) disk (FD) drive 906, a keyboard 902, a mouse 903, and a monitor 904.

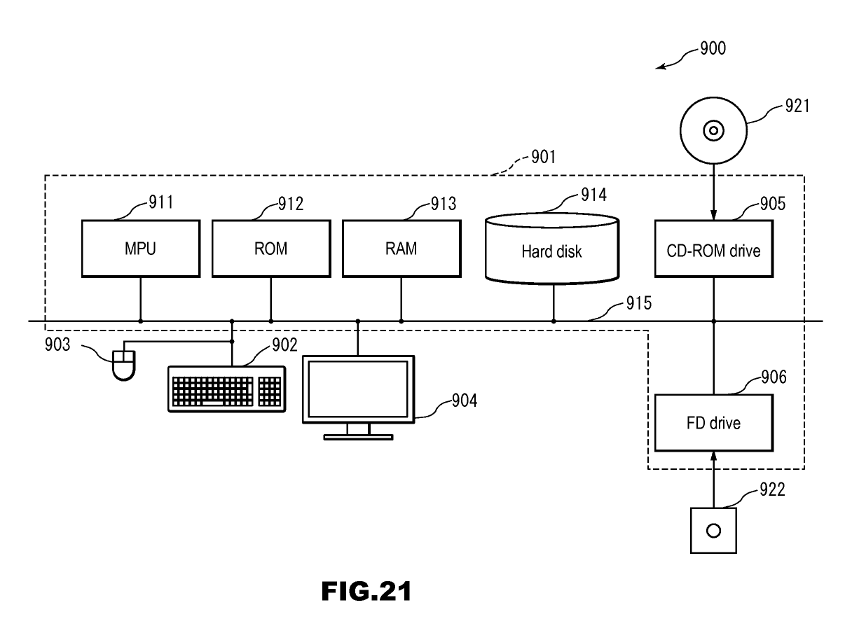

FIG. 21 is a diagram showing an internal configuration of the computer system 900. In FIG. 21, the computer 901 is provided with, in addition to the CD-ROM drive 905 and the FD drive 906, a micro processing unit (MPU) 911, a ROM 912 in which a program such as a boot up program is to be stored, a random access memory (RAM) 913 that is connected to the MPU 911 and in which a command of an application program is temporarily stored and a temporary storage area is to be provided, a hard disk 914 in which an application program, a system program, and data are stored, and a bus 915 that connects the MPU 911, the ROM 912, and the like. Note that the computer 901 may include an unshown network card for providing a connection to a LAN.

The program for causing the computer system 900 to execute the functions of the information processing apparatus and the like in the foregoing example may be stored in a CD-ROM 921 or an FD 922 that is inserted into the CD-ROM drive 905 or the FD drive 906, and be transmitted to the hard disk 914. Alternatively, the program may be transmitted via an unshown network to the computer 901 and stored in the hard disk 914. At the time of execution, the program is loaded into the RAM 913. The program may be loaded from the CD-ROM 921 or the FD 922, or directly from a network.

The program does not necessarily have to include, for example, an operating system (OS) or a third party program to cause the computer 901 to execute the functions of the information processing apparatus in the foregoing example. The program may only include a command portion to call an appropriate function (module) in a controlled mode and obtain desired results. The manner in which the computer system 900 operates is well known, and, thus, a detailed description thereof has been omitted.

The present invention is not limited to the examples set forth herein. Various modifications are possible within the scope of the invention.

As described above, the information processing apparatus and the like according to the present invention are suitable as an apparatus and the like for processing accounting information, and are particularly useful as an apparatus and the like used for acquiring information of a slip corresponding to a receipt.

1. An information processing apparatus, comprising:
a receipt image storage unit in which a receipt image, which is an image of a receipt, is stored;
a receipt image receiving unit that receives the receipt image;
a receipt image accumulating unit that accumulates the receipt image received by the receipt image receiving unit, in the receipt image storage unit;
a slip information storage unit in which a slip information record is stored, the slip information record being a record in which slip information, which is information of a slip relating to the receipt image, is stored; and
an association providing unit that associates the receipt image stored in the receipt image storage unit, with the slip information record in which the slip information relating to that receipt image is to be stored.

2. The information processing apparatus according to claim 1, further comprising a record generating unit that automatically generates a slip information record in which slip information corresponding to the receipt image received by the receipt image receiving unit is to be stored, and accumulates the automatically generated slip information record in the slip information storage unit,
wherein the association providing unit associates the slip information record generated by the record generating unit with the receipt image corresponding to the slip information record stored in the receipt image storage unit.

3. The information processing apparatus according to claim 2, further comprising a slip information acquiring unit that performs image recognition processing on the receipt image received by the receipt image receiving unit, thereby acquiring slip information of the receipt image, and accumulates the acquired slip information in the slip information record associated with the receipt image, generated by the record generating unit.

4. The information processing apparatus according to claim 3, further comprising:
a journal information storage unit in which journal information, which is information obtained by journalizing a transaction shown in the receipt image, is stored; and
a journal information acquiring unit that acquires information regarding a purchase indicated by the receipt shown in the receipt image, from information acquired by the slip information acquiring unit performing image recognition processing on the receipt image, acquires information of an account title corresponding to the purchase, acquires journal information having the information of the account title, using the information regarding the purchase, and accumulates the journal information in the journal information storage unit.

5. The information processing apparatus according to claim 1,
wherein the receipt image receiving unit receives the receipt image and client identifying information, which is information for identifying a client, and
the receipt image accumulating unit accumulates the receipt image received by the receipt image receiving unit in association with the client identifying information received by the receipt image receiving unit, in the receipt image storage unit.

6. The information processing apparatus according to claim 2, wherein the record generating unit performs image recognition processing on the receipt image received by the receipt image receiving unit, detects at least one purchase contained in the receipt image, automatically generates a slip information record for each detected purchase, and accumulates the slip information record in the slip information storage unit.

7. The information processing apparatus according to claim 1,
wherein the receipt image accumulating unit acquires a receipt image, for each receipt, from the receipt image containing images of multiple receipts received by the receipt image receiving unit, and accumulates each receipt image in the receipt image storage unit, and
the record generating unit generates a slip information record, for each receipt image acquired for the receipts by the receipt image accumulating unit from the receipt image containing the images of the multiple receipts received by the receipt image receiving unit.

8. An information processing method performed using: a receipt image storage unit in which a receipt image, which is an image of a receipt, is stored; a receipt image receiving unit; a receipt image accumulating unit; a slip information storage unit in which a slip information record is stored, the slip information record being a record in which slip information, which is information of a slip relating to the receipt image, is stored; and an association providing unit, the method comprising:
a receipt image receiving step of the receipt image receiving unit receiving the receipt image;
a receipt image accumulating step of the receipt image accumulating unit accumulating the receipt image received in the receipt image receiving step, in the receipt image storage unit; and
an association providing step of the association providing unit associating the receipt image stored in the receipt image storage unit, with the slip information record in which the slip information relating to that receipt image is to be stored.

9. A non-transitory computer readable storage medium in which a program is stored, the program being used in a state where a computer makes access to: a receipt image storage unit in which a receipt image, which is an image of a receipt, is stored; and a slip information storage unit in which a slip information record is stored, the slip information record being a record in which slip information, which is information of a slip relating to the receipt image, is stored, the program causing the computer to function as:
a receipt image receiving unit that receives the receipt image;
a receipt image accumulating unit that accumulates the receipt image received by the receipt image receiving unit, in the receipt image storage unit; and
an association providing unit that associates the receipt image stored in the receipt image storage unit, with the slip information record in which the slip information relating to that receipt image is stored.
